(19) United States
(12) Patent Application Publication
(10) Pub. No.: US 2025/0299888 A1
(43) Pub. Date: Sep. 25, 2025

(54) COMPOSITE ELECTRONIC COMPONENT

(71) Applicant: Murata Manufacturing Co., Ltd., Nagaokakyo-shi (JP)

(72) Inventors: Tomohiro SASAKI, Nagaokakyo-shi (JP); Masahiro SAKURATANI, Nagaokakyo-shi (JP)

(21) Appl. No.: 19/030,574

(22) Filed: Jan. 17, 2025

(30) Foreign Application Priority Data
Mar. 21, 2024 (JP) 2024-044670

(51) Int. Cl. H01G 4/35; H01G 2/06; H01G 4/012; H01G 4/224; H01G 4/232; H01G 4/30

(52) U.S. Cl. CPC H01G 4/35; H01G 2/065; H01G 4/012; H01G 4/224; H01G 4/2325; H01G 4/30

(57) ABSTRACT

A composite electronic component includes a multilayer ceramic capacitor and a conductor portion. The multilayer ceramic capacitor includes a multilayer body including first, second, third, fourth, fifth, and sixth surfaces, a first external electrode on the first and third surfaces, a second external electrode on the first and fourth surfaces, a third external electrode on the fifth and first surfaces, and a fourth external electrode on the sixth and first surfaces. The conductor portion is electrically connected to the first and second external electrodes. The first external electrode includes a first region on the first surface and a second region on the third surface. The conductor portion includes first and second electrodes respectively connected to the first and second external electrodes by first and second electrically conductive adhesives. Rdc2≤Rdc1 is satisfied. The first electrically conductive adhesive extends from the first region to the second region.

### CROSS REFERENCE TO RELATED APPLICATIONS

This application claims the benefit of priority to Japanese Patent Application No. 2024-044670 filed on Mar. 21, 2024. The entire contents of this application are hereby incorporated herein by reference.

### BACKGROUND OF THE INVENTION

### 1. Field of the Invention

The present invention relates to composite electronic components.

### 2. Description of the Related Art

For example, as a decoupling capacitor used to stabilize a power supply voltage supplied to an integrated circuit component (IC) that operates at high speed, and as noise countermeasure component of a power supply line supplied to an integrated circuit component (IC), a feed-through three-terminal capacitor has been known. The feed-through three-terminal capacitor generally includes a multilayer body including first and second main surfaces opposed to each other, fifth and sixth surfaces opposed to each other, and third and fourth surfaces opposed to each other. The multilayer body includes a plurality of first internal electrode layers and a plurality of second internal electrode layers alternately provided in the lamination direction therein. The plurality of first internal electrode layers each include two ends respectively extending toward and exposed at the third surface and the fourth surface, and the plurality of second internal electrode layers each include two ends respectively extending toward and exposed at the fifth surface and the sixth surface. Further, the plurality of first internal electrode layers are each connected to the first external electrode and the second external electrode, and the plurality of second internal electrode layers are each connected to the third external electrode and the fourth external electrode.

When a general feed-through three-terminal capacitor is used as a noise filter, a DC current flows through the signal internal electrode (first internal electrode layer). However, when the capacitance becomes low, the number of signal internal electrodes (first internal electrode layers) becomes small and DC resistance increases. This causes a problem in that the heat generated from the capacitor becomes large.

In this regard, the configuration disclosed in Japanese Unexamined Patent Application Publication No. H09-55335 is provided as a configuration of a low-capacitance feed-through three-terminal capacitor that is able to reduce or prevent an increase in DC resistance, while reducing or preventing an increase in electrostatic capacitance. When the number of signal internal electrodes (first internal electrode layers) is increased and the signal internal electrodes (first internal electrode layers) are opposed to each other, both of the electrostatic capacitance and the DC resistance are suppressed.

However, there is room for improvement in a configuration such as that disclosed in Japanese Unexamined Patent Application Publication No. H09-55335. That is, there is a limitation in increasing the number of signal internal electrodes (first internal electrode layers) within a predetermined size constraint, and it is difficult to handle further large current. Further, it is necessary to design the internal structure uniformly for each capacitance, and the development of the product lineup is poor. In addition, when the volume of the metal component in the ridge portion of the multilayer ceramic capacitor becomes small, the electrical resistance becomes high.

### SUMMARY OF THE INVENTION

Example embodiments of the present invention provide composite electronic components that are each able to reduce or prevent an increase in electrical resistance, while handling a large current.

A composite electronic component according to an example embodiment of the present invention includes a multilayer ceramic capacitor and a conductor portion. The multilayer ceramic capacitor includes a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction, a first external electrode on the first surface and the third surface, a second external electrode on the first surface and the fourth surface, a third external electrode on the fifth surface and the first surface, and a fourth external electrode on the sixth surface and the first surface. The conductor portion is electrically connected to the first external electrode and the second external electrode. The first external electrode includes a first region on a surface adjacent to the first surface and a second region on a surface adjacent to the third surface. The conductor portion includes a first electrode connected to the first external electrode by a first electrically conductive adhesive, and a second electrode connected to the second external electrode by a second electrically conductive adhesive. When a DC resistance of the multilayer ceramic capacitor is defined as Rdc1 and a DC resistance of the conductor portion is defined as Rdc2, Rdc2≤Rdc1 is satisfied. The first electrically conductive adhesive extends from the first region to the second region of the first external electrode.

In a composite electronic component according to an example embodiment of the present invention, when a DC resistance of the multilayer ceramic capacitor is defined as Rdc1 and a DC resistance of the conductor portion is defined as Rdc2, Rdc2≤Rdc1 is satisfied. This allows the AC current to flow preferentially through the multilayer ceramic capacitor having a low impedance, and allows the DC current to flow through the side having a low DC resistance. Since the first electrically conductive adhesive extends from the first region to the second region in the first external electrode, the volume of the metal component in at least one ridge portion of the multilayer ceramic capacitor is increased, such that it is possible to reduce or prevent an increase in electrical resistance.

According to example embodiments of the present invention, it is possible to provide composite electronic components that are each able to reduce or prevent an increase in electrical resistance while handling a large current.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing a composite electronic component according to a first example embodiment of the present invention.

FIG. 2 is a front view of the composite electronic component according to the first example embodiment of the present invention.

FIG. 3 is a bottom view of the composite electronic component according to the first example embodiment of the present invention.

FIG. 4 is a plan view of the composite electronic component according to the first example embodiment of the present invention.

FIG. 5 is a cross-sectional view taken along the line V-V of FIG. 3.

FIG. 6A is an enlarged view of a portion A in FIG. 5, and FIG. 6B is an enlarged view of a portion B in FIG. 5.

FIG. 7 is a cross-sectional view taken along the line VII-VII of FIG. 2.

FIG. 8A is an external perspective view of a multilayer ceramic capacitor included in the composite electronic component according to the first example embodiment of the present invention, and FIG. 8B is an external perspective view of the multilayer ceramic capacitor from another direction.

FIG. 9 is an exploded perspective view schematically showing a configuration of a main portion of the multilayer ceramic capacitor included in the composite electronic component according to the first example embodiment of the present invention.

FIG. 10 is an exploded perspective view schematically showing a configuration of a main portion of the multilayer ceramic conductor component (chip-type coil component) included in the composite electronic component according to the first example embodiment of the present invention.

FIG. 11 is a cross-sectional view in the lamination direction showing a mounting structure of the composite electronic component according to the first example embodiment of the present invention.

FIG. 12 is an external perspective view showing a composite electronic component according to a second example embodiment of the present invention.

FIG. 13 is a front view of the composite electronic component according to the second example embodiment of the present invention.

FIG. 14 is a cross-sectional view taken along the line XIV-XIV of FIG. 12.

FIG. 15 is a cross-sectional view showing an example of a conductor portion included in the composite electronic component according to the second example embodiment of the present invention.

FIG. 16A is a cross-sectional view showing a first modification of the conductor portion according to the second example embodiment of the present invention.

FIG. 16B is a cross-sectional view showing a second modification of the conductor portion according to the second example embodiment of the present invention.

FIG. 16C is a cross-sectional view showing a third modification of the conductor portion according to the second example embodiment of the present invention.

FIG. 16D is a cross-sectional view showing a fourth modification of the conductor portion according to the second example embodiment of the present invention.

FIG. 17 is a cross-sectional view in a lamination direction showing a mounting structure of the composite electronic component according to the second example embodiment of the present invention.

FIG. 18 is an external perspective view showing a composite electronic component according to a third example embodiment of the present invention.

FIG. 19A is a front view of the composite electronic component according to the third example embodiment of the present invention, and FIG. 19B is a rear view of the composite electronic component according to the third example embodiment of the present invention.

FIG. 20 is an external perspective view showing a composite electronic component according to a fourth example embodiment of the present invention.

FIG. 21 is a front view of the composite electronic component according to the fourth example embodiment of the present invention.

FIG. 22 is a cross-sectional view showing a first modification of a multilayer ceramic capacitor according to an example embodiment of the present invention.

FIG. 23 is a cross-sectional view showing the first modification of a multilayer ceramic capacitor according to an example embodiment of the present invention.

FIG. 24 is a cross-sectional view showing a dielectric layer to which a first internal electrode layer is provided in the first modification of a multilayer ceramic capacitor according to an example embodiment of the present invention.

FIG. 25 is a cross-sectional view showing a dielectric layer to which a second internal electrode layer is provided in the first modification of a multilayer ceramic capacitor according to an example embodiment of the present invention.

FIG. 26 is a cross-sectional view showing a second modification of a multilayer ceramic capacitor according to an example embodiment of the present invention.

FIG. 27 is a cross-sectional view showing the second modification of a multilayer ceramic capacitor according to an example embodiment of the present invention.

### DETAILED DESCRIPTION OF THE EXAMPLE EMBODIMENTS

### 1. Composite Electronic Component

A composite electronic component 1 according to an example embodiment of the present invention will be described with reference to the drawings.

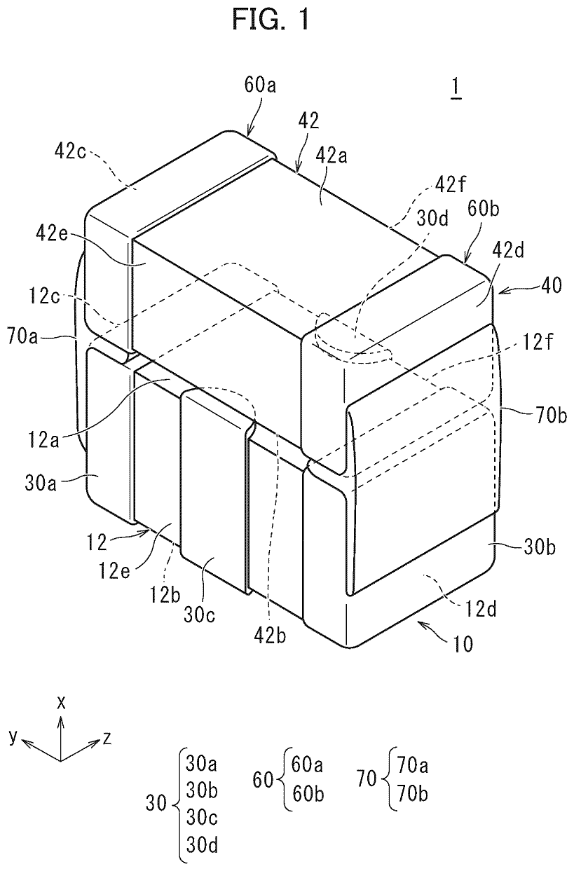

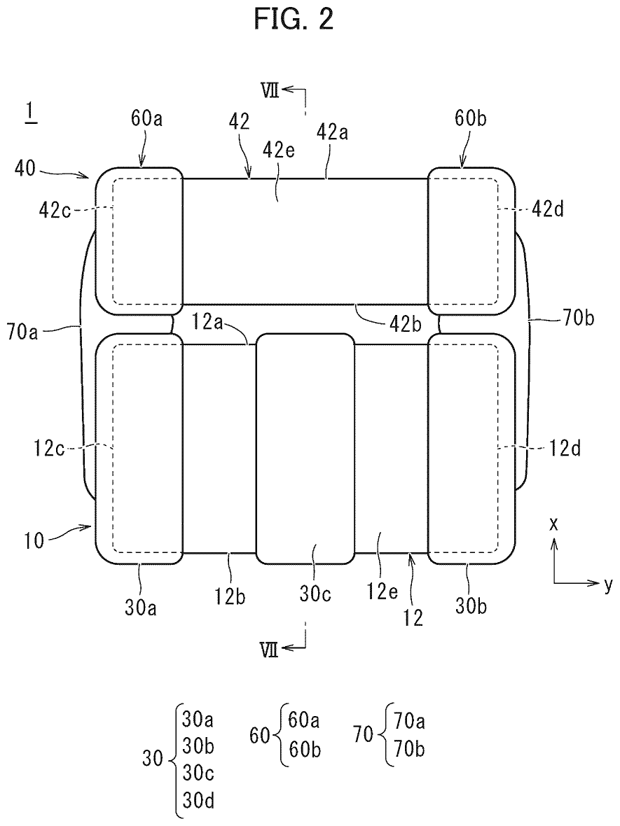

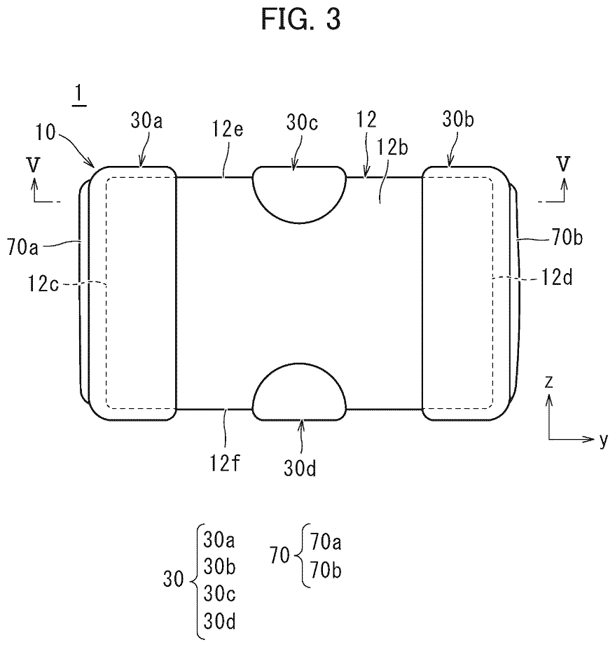

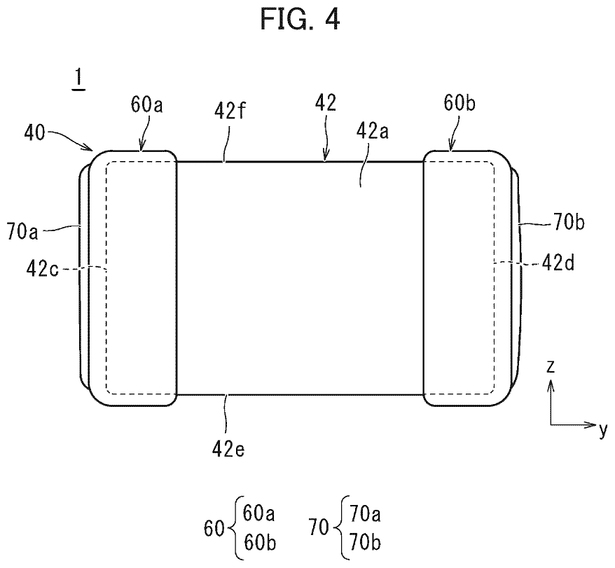

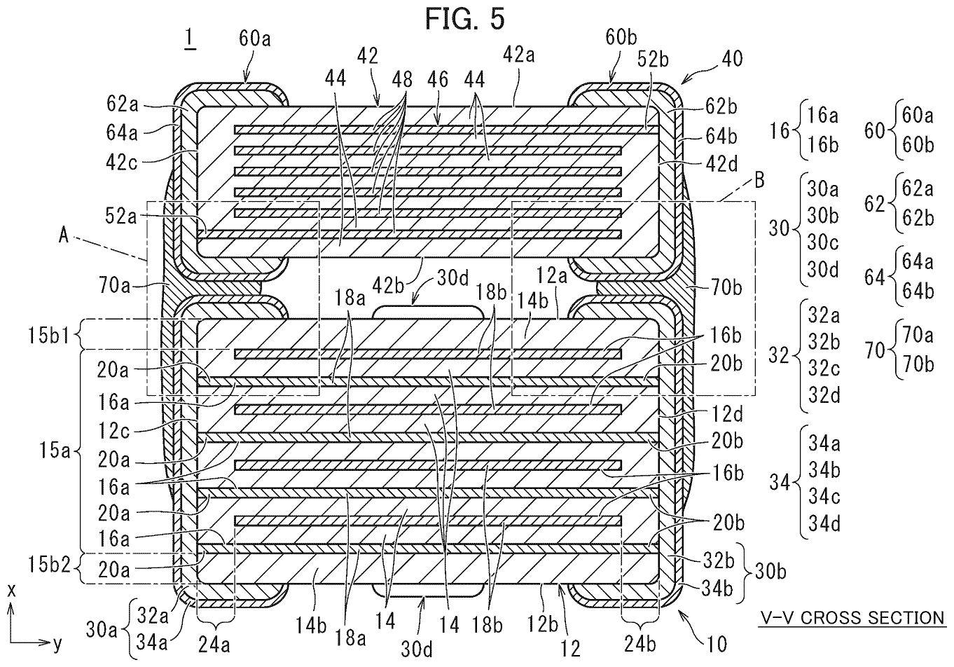

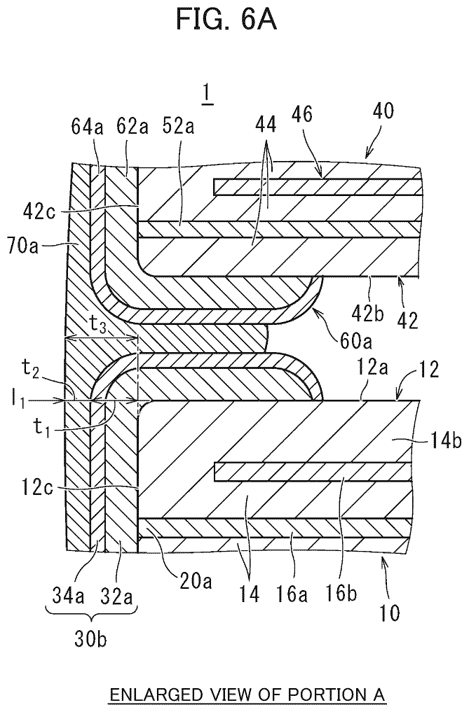

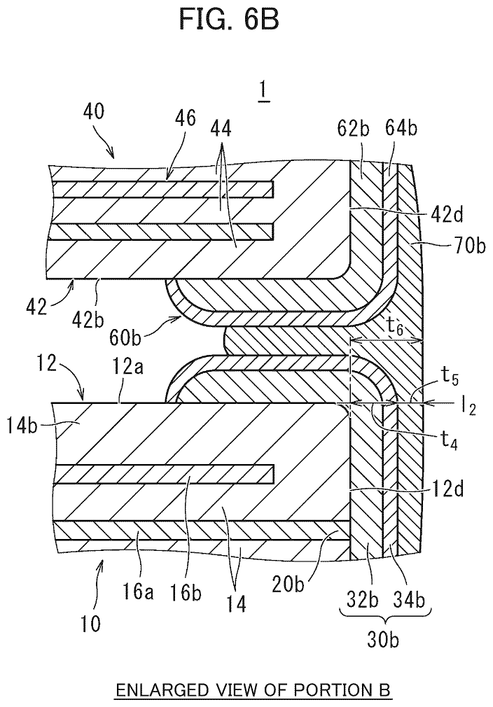

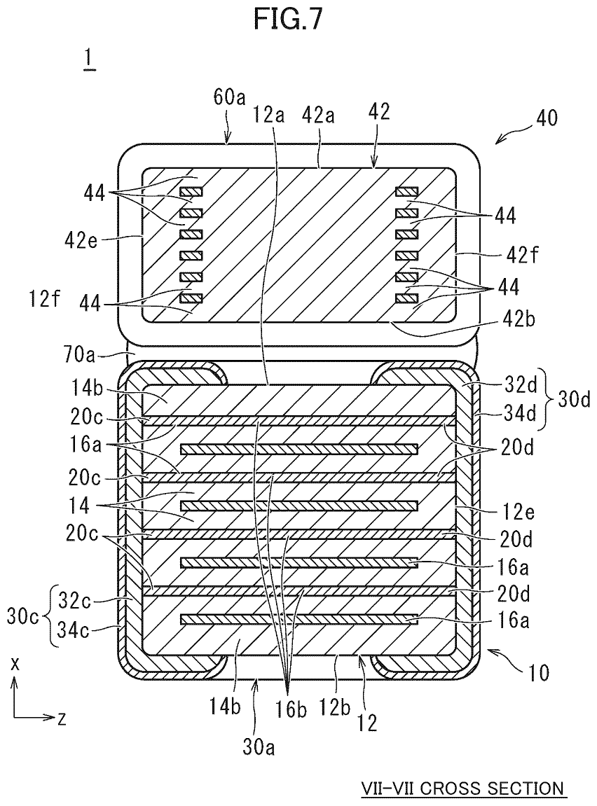

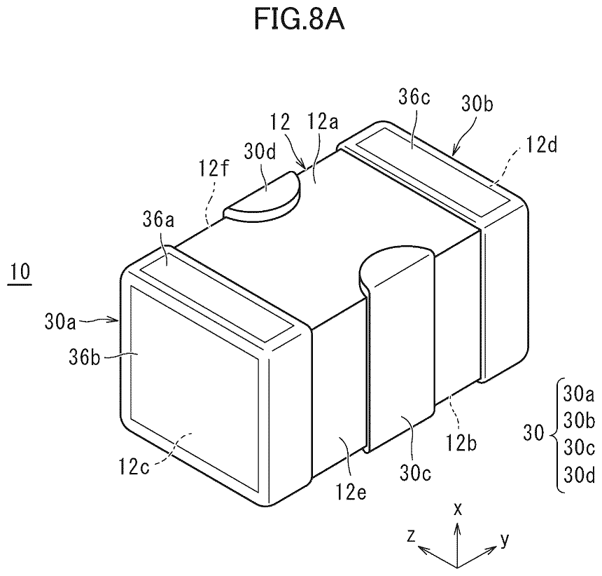

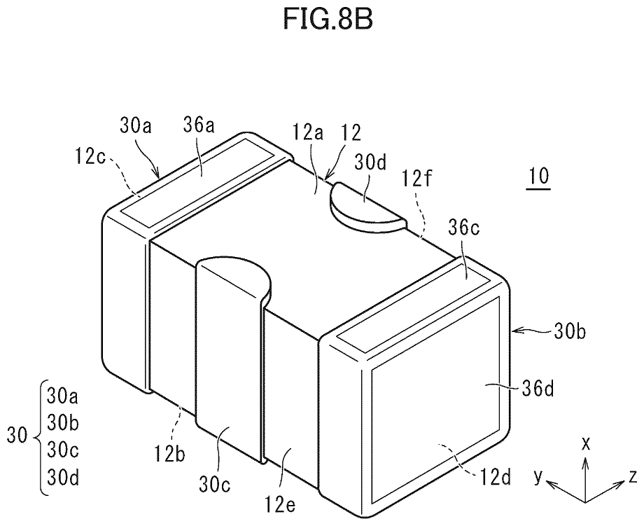

FIG. 1 is an external perspective view showing a composite electronic component according to a first example embodiment of the present invention. FIG. 2 is a front view of the composite electronic component according to the first example embodiment of the present invention. FIG. 3 is a bottom view of the composite electronic component according to the first example embodiment of the present invention. FIG. 4 is a plan view of the composite electronic component according to the first example embodiment of the present invention. FIG. 5 is a cross-sectional view taken along the line V-V of FIG. 1. FIG. 6A is an enlarged view of a portion A in FIG. 5, and FIG. 6B is an enlarged view of a portion B in FIG. 5. FIG. 7 is a cross-sectional view taken along the line VII-VII of FIG. 1. FIG. 8A is an external perspective view of a multilayer ceramic capacitor included in the composite electronic component according to the first example embodiment of the present invention, and FIG. 8B is an external perspective view of the multilayer ceramic capacitor from another direction. FIG. 9 is an exploded perspective view schematically showing a configuration of a main portion of the multilayer ceramic capacitor included in the composite electronic component according to the first example embodiment of the present invention. FIG. 10 is an exploded perspective view schematically showing a configuration of a main portion of the multilayer ceramic conductor component (chip-type coil component) included in the composite electronic component according to the first example embodiment of the present invention.

As shown in FIGS. 1 to 7, the composite electronic component 1 according to the present example embodiment of the present invention includes a multilayer ceramic capacitor 10 and a conductor portion 40.

### (a) Multilayer Ceramic Capacitor

The multilayer ceramic capacitor 10 according to the present example embodiment of the present invention will be described.

The multilayer ceramic capacitor 10 includes a first multilayer body 12 and an external electrode 30. Hereinafter, each configuration will be described in the order of the first multilayer body 12 and the external electrode 30.

### First Multilayer Body

The first multilayer body 12 includes a plurality of laminated dielectric layers 14. Further, the first multilayer body 12 includes a first surface 12a and a second surface 12b opposed to each other in the lamination direction x, a third surface 12c and a fourth surface 12d opposed to each other in the first direction y orthogonal or substantially orthogonal to the lamination direction x, and a fifth surface 12e and a sixth surface 12f opposed to each other in the second direction z orthogonal or substantially orthogonal to the lamination direction x and the first direction y. The first multilayer body 12 has a rectangular or substantially rectangular parallelepiped shape. Further, the first multilayer body 12 preferably includes rounded corner portions and ridge portions. Each of the corner portions refers to a portion where three adjacent surfaces of the first multilayer body 12 intersect, and each of the ridge portions refers to a portion where two adjacent surfaces of the first multilayer body 12 intersect. Further, the first surface 12a and the second surface 12b, the third surface 12c and the fourth surface 12d, and the fifth surface 12e and the sixth surface 12f may be partially or entirely uneven.

As shown in FIG. 5, the first multilayer body 12 includes an inner layer portion 15a in which a plurality of internal electrode layers 16 are alternately provided with a dielectric layer 14 interposed therebetween, a first outer layer portion 15b1 located adjacent to the first surface 12a and including a plurality of dielectric layers 14 located between the first surface 12a and the outermost surface of the inner layer portion 15a adjacent to the first surface 12a, and a second outer layer portion 15b2 located adjacent to the second surface 12b and including a plurality of dielectric layers 14 located between the second surface 12b and the outermost surface of the inner layer portion 15a adjacent to the second surface 12b.

Here, the plurality of dielectric layers 14 for the inner layer defining the inner layer portion 15a are sandwiched between first internal electrode layers 16a and second internal electrode layers 16b described later.

The number of the laminated dielectric layers 14 is not particularly limited, but is, for example, preferably 10 or more and 1000 or less including the first outer layer portion 15bl and the second outer layer portion 15b2. Further, the thickness of each of the dielectric layers 14 is, for example, preferably about 0.5 μm or more and about 15 μm or less.

Each of the dielectric layers 14 can be made of a dielectric material, for example, as a ceramic material. As such a dielectric material, for example, a dielectric ceramic including components such as BaTiO₃, CaTiO₃, SrTiO₃, and CaZrO₃ can be used. In addition, in a case where the dielectric material is included as a main component, a subcomponent having a content smaller than that of the main component, such as, for example, a Mn compound, a Fe compound, a Cr compound, a Co compound, or a Ni compound, may be added according to the desired characteristics of the first multilayer body 12.

Further, for example, each of the dielectric layers 14 may include a plurality of crystal grains including a perovskite compound having BaTiO₃ as a basic structure. The size of the crystal grains is appropriately designed according to the thickness of each of the dielectric layers 14. In the case of this example embodiment, the capacitance of a capacitor is larger as each of the dielectric layers 14 is thinner, and therefore the crystal grain size is, for example, preferably about 1 μm or less.

Further, the dielectric layers 14 for the outer layer defining the first outer layer portion 15b1 and the second outer layer portion 15b2 are made of the same dielectric ceramic material as the dielectric layer 14 of the inner layer portion 15a. In addition, the dielectric layers 14 of the first outer layer portion 15b1 and the second outer layer portion 15b2 may be made of a material different from that of the dielectric layer 14 of the inner layer portion 15a. In addition, each of the dielectric layers 14 of the first outer layer portion 15bl and the second outer layer portion 15b2 may include a plurality of layers or a single layer. Further, in a case in which the dielectric layers 14 of the first outer layer portion 15b1 and the second outer layer portion 15b2 each include a multilayer structure, it is preferable that segregation portions of Si of the dielectric layers 14 of the first outer layer portion 15b1 and the second outer layer portion 15b2 respectively located closest to the first internal electrode layer 16a and the second internal electrode layer 16b are less than segregation portions of Si of the other dielectric layers 14 of the first outer layer portion 15bl and the second outer layer portion 15b2. This can improve the flexural strength of the multilayer ceramic capacitor 10 from the lamination direction x.

The first multilayer body 12 includes side portions 22a and 22b (hereinafter, each referred to as a “W gap”) of the first multilayer body 12 located between the first internal electrode layer 16a and the fifth surface 12e and between the first internal electrode layer 16a and the sixth surface 12f.

Further, the first multilayer body 12 includes end portions 24a and 24b (hereinafter, each referred to as an “L gap”) of the first multilayer body 12 located between the second internal electrode layer 16b and the third surface 12c and between the second internal electrode layer 16b and the fourth surface 12d.

### Internal Electrode Layer

As shown in FIGS. 5 and 9, the internal electrode layer 16 includes the first internal electrode layers 16a each exposed on the third surface 12c and the fourth surface 12d, and the second internal electrode layers 16b each exposed on the fifth surface 12e and the sixth surface 12f.

Each of the first internal electrode layers 16a includes a first counter electrode portion 18a opposed to a corresponding one of the second internal electrode layers 16b, a first extension electrode portion 20a located on one end of the first internal electrode layer 16a and extending from the first counter electrode portion 18a to the third surface 12c of the first multilayer body 12, and a second extension electrode portion 20b located on one end of the first internal electrode layer 16a and extending from the first counter electrode portion 18a to the fourth surface 12d of the first multilayer body 12.

Each of the second internal electrode layers 16b includes a second counter electrode portion 18b opposed to a corresponding one of the first internal electrode layers 16a, a third extension electrode portion 20c located on one end of the second internal electrode layer 16b and extending from the second counter electrode portion 18b to the fifth surface 12e of the first multilayer body 12, and a fourth extension electrode portion 20d located on one end of the second internal electrode layer 16b and extending from the second counter electrode portion 18b to the sixth surface 12f of the first multilayer body 12.

The shape of the first counter electrode portion 18a of the first internal electrode layer 16a is not particularly limited, but is preferably rectangular or substantially rectangular in a plan view. However, the corner portion in a plan view may be rounded, or the corner portion may be provided obliquely in a plan view (tapered shape). Alternatively, the first counter electrode portion 18a may have a tapered shape in a plan view which is sloped toward either side.

The shape of the second counter electrode portion 18b of the second internal electrode layer 16b is not particularly limited, but is preferably rectangular or substantially rectangular in a plan view. However, the corner portion in a plan view may be rounded, or the corner portion may be provided obliquely in a plan view (tapered shape). Alternatively, the second counter electrode portion 18b may have a tapered shape in a plan view which is sloped toward either side.

The shapes of the first extension electrode portion 20a and the second extension electrode portion 20b of the first internal electrode layer 16a are not particularly limited, but are preferably rectangular or substantially rectangular in a plan view. However, the corner portions in a plan view may be rounded, or the corner portions may be provided obliquely in a plan view (tapered shape). Alternatively, each of the first extension electrode portion 20a and the second extension electrode portion 20b may have a tapered shape in a plan view which is sloped toward either side.

The shapes of the third extension electrode portion 20c and the fourth extension electrode portion 20d of the second internal electrode layer 16b are not particularly limited, but are preferably rectangular or substantially rectangular in a plan view. However, the corner portions in a plan view may be rounded, or the corner portions may be provided obliquely in a plan view (tapered shape). Alternatively, each of the third extension electrode portion 20c and the fourth extension electrode portion 20d may have a tapered shape in a plan view which is sloped toward either side.

The first counter electrode portion 18a of the first internal electrode layer 16a may have the same or substantially the same width as those of the first extension electrode portion 20a and the second extension electrode portion 20b of the first internal electrode layer 16a, or either one of them may have a narrower width than the other.

The second counter electrode portion 18b of the second internal electrode layer 16b may have the same or substantially the same width as those of the third extension electrode portion 20c and the fourth extension electrode portion 20d of the second internal electrode layer 16b, or either one of them may have a narrower width than the other.

In this example embodiment, the widths in the first direction y of the third extension electrode portion 20c and the fourth extension electrode portion 20d of the second internal electrode layer 16b are narrower than the width in the first direction y of the second counter electrode portion 18b of the second internal electrode layer 16b.

Further, each of the first internal electrode layers 16a preferably has a uniform or substantially uniform thickness, but the thickness of the edge portion of each of the first internal electrode layers 16a may be thicker than the thickness of the middle portion thereof. When the thickness of each of the first internal electrode layers 16a is increased, the coverage is improved. Therefore, the current path becomes short, and the ESL characteristics are improved. Further, the thickness of the edge portion of each of the first internal electrode layers 16a may be smaller than the thickness of the middle portion. By reducing the thickness, a step difference corresponding to the thickness of each of the first internal electrode layers 16a is relaxed, and structural defects are reduced or prevented.

Each of the first internal electrode layers 16a and each of the second internal electrode layers 16b can be made of, for example, a metal such as Ni, Cu, Ag, Pd, or Au, or an appropriate electrically conductive material such as an alloy including at least one of these metals such as an Ag—Pd alloy, but are not limited thereto. In addition, since each of the first internal electrode layers 16a and each of the second internal electrode layers 16b include Sn, the concentration of an electric field at the interface can be relaxed, which leads to an improvement in reliability of high-temperature load. At this time, even if Sn is included in only one of the first internal electrode layer 16a or the second internal electrode layer 16b, the advantageous effect still can be sufficiently achieved.

In this example embodiment, the first counter electrode portion 18a of each of the first internal electrode layers 16a and the second counter electrode portion 18b of each of the second internal electrode layers 16b are opposed to each other with the dielectric layer 14 interposed therebetween, such that capacitance is generated and the characteristics of the capacitor are developed.

The thickness of each of the first internal electrode layers 16a and each of the second internal electrode layers 16b is, for example, preferably about 0.5 μm or more and about 1.5 μm or less. In addition, the number of laminated first internal electrode layers 16a and second internal electrode layers 16b is appropriately changed according to the size or the like. When the number of the first internal electrode layers 16a increases, an increase in DC resistance can be reduced. The total number of the first internal electrode layers 16a and the second internal electrode layers 16b is, for example, preferably 10 or more and 1000 or less.

The first extension electrode portion 20a and the second extension electrode portion 20b of each of the first internal electrode layers 16a may be curved. Further, the third extension electrode portion 20c and the fourth extension electrode portion 20d of each of the second internal electrode layers 16b may be curved. At this time, at least one of the first extension electrode portion 20a and the second extension electrode portion 20b of each of the first internal electrode layers 16a and the third extension electrode portion 20c and the fourth extension electrode portion 20d of each of the second internal electrode layers 16b may be curved toward either one of the first surface 12a or the second surface 12b. In this case, it is possible to shorten the current path by making a mounting surface curved.

The distance between the first internal electrode layer 16a closest to the first surface 12a and the first internal electrode layer 16a closest to the second surface 12b of the first internal electrode layer 16a among the first internal electrode layers 16a extending toward and exposed on the third surface 12c and the fourth surface 12d may be shorter than the distance between the first counter electrode portion 18a of the first internal electrode layer 16a closest to the first surface 12a and the first counter electrode portion 18a of the first internal electrode layer 16a closest to the second surface 12b.

Further, the distance between the second internal electrode layer 16b closest to the first surface 12a and the second internal electrode layer 16b closest to the second surface 12b of the second internal electrode layer 16b among the second internal electrode layers 16b extending toward and exposed on the fifth surface 12e and the sixth surface 12f may be shorter than the distance between the second counter electrode portion 18b of the second internal electrode layer 16b closest to the first surface 12a and the second counter electrode portion 18b of the second internal electrode layer 16b closest to the second surface 12b.

In order to increase the capacitance of the capacitor, it is necessary to increase the area of each of the internal electrode layers 16, and thus the LW surface coverage of the internal electrode layer 16 is, for example, preferably about 90% or more. Here, the LW surface coverage of each of the internal electrode layers 16 is defined as a ratio obtained by subtracting the area of a gap from the area inside the edge portion of an internal electrode layer 16 when viewed from the LW surface of the first multilayer body 12. When the LW surface coverage of each of the internal electrode layers 16 is higher, the capacitance of the capacitor is higher, but even when the LW surface coverage is low, since the dielectric layers 14 are bonded to each other via gaps, the bonding strength between the layers is high, and interlayer peeling is less likely to occur.

### External Electrode

The external electrode 30 includes a first external electrode 30a, a second external electrode 30b, a third external electrode 30c, and a fourth external electrode 30d.

The first external electrode 30a is connected to the first internal electrode layers 16a and provided on the third surface 12c. Further, the first external electrode 30a extends around a portion of the first surface 12a and a portion of the second surface 12b. In addition, it is preferable that the first external electrode 30a extends from the third surface 12c slightly around a portion of the fifth surface 12e and a portion of the sixth surface 12f.

The second external electrode 30b is connected to the first internal electrode layers 16a and provided on the fourth surface 12d. Further, the second external electrode 30b extends around a portion of the first surface 12a and a portion of the second surface 12b. In addition, it is preferable that the second external electrode 30b extends from the fourth surface 12d slightly around a portion of the fifth surface 12e and a portion of the sixth surface 12f.

As illustrated in FIG. 8A, the first external electrode 30a includes a first region 36a provided on the surface on the first surface 12a and a second region 36b provided on the surface on the third surface 12c.

As illustrated in FIG. 8B, the second external electrode 30b includes a third region 36c provided on the surface on the first surface 12a and a fourth region 36d provided on the surface on the fourth surface 12d.

On the first surface 12a, the thickness of each of the first external electrode 30a and the second external electrode 30b in the lamination direction x is, for example, preferably about 5 μm or more and about 15 μm or less. The thickness of each of the first external electrode 30a and the second external electrode 30b is defined by the total thickness of a base electrode layer 32 and a plated layer 34 described later.

The thickness of each of the first external electrode 30a and the second external electrode 30b in the lamination direction x is measured by an example of a method described below. That is, the first multilayer body 12 is polished to about one half of the dimension in the second direction z so as to expose the surface (LT surface) in the first direction y and the lamination direction x. The first external electrode 30a and the second external electrode 30b provided on the first surface 12a are observed with a digital microscope (VHX-8000 manufactured by Keyence Corporation) at a magnification of 1500 times in a cross section (LT plane) in the first direction y and the lamination direction x obtained by polishing. In this case, the thickest portions of the first external electrode 30a and the second external electrode 30b provided on the first surface 12a are defined as the respective thicknesses.

The third external electrode 30c is connected to the second internal electrode layers 16b and provided on the fifth surface 12e. In addition, it is preferable that the third external electrode 30c is provided on a portion of the first surface 12a and a portion of the second surface 12b. In addition, the third external electrode 30c may be provided on one of a portion of the first surface 12a or a portion of the second surface 12b continuously from the fifth surface 12e.

The fourth external electrode 30d is connected to the second internal electrode layers 16b and provided on the sixth surface 12f. In addition, it is preferable that the fourth external electrode 30d is provided on a portion of the first surface 12a and a portion of the second surface 12b. In addition, the fourth external electrode 30d may be provided on one of a portion of the first surface 12a or a portion of the second surface 12b continuously from the sixth surface 12f.

The third external electrode 30c and the fourth external electrode 30d may be directly bonded to each other.

The first external electrode 30a includes a first base electrode layer 32a including an electrically conductive metal provided on the first multilayer body 12, and a first plated layer 34a covering the first base electrode layer 32a. The second external electrode 30b includes a second base electrode layer 32b including an electrically conductive metal provided on the first multilayer body 12, and a second plated layer 34b covering the second base electrode layer 32b. The third external electrode 30c includes a third base electrode layer 32c including an electrically conductive metal provided on the first multilayer body 12, and includes a third plated layer 34c covering the third base electrode layer 32c. The fourth external electrode 30d includes a fourth base electrode layer 32d including an electrically conductive metal provided on the first multilayer body 12, and a fourth plated layer 34d covering the fourth base electrode layer 32d.

The base electrode layer 32 includes a first base electrode layer 32a, a second base electrode layer 32b, a third base electrode layer 32c, and a fourth base electrode layer 32d. The first base electrode layer 32a, the second base electrode layer 32b, the third base electrode layer 32c, and the fourth base electrode layer 32d include, for example, at least one of a fired layer, an electrically conductive resin layer, a thin film layer, or the like.

The fired layer includes a glass component and a metal. The fired layer may include a plurality of layers.

The glass component of the fired layer includes, for example, at least one of B, Si, Ba, Mg, Al, Li, or the like.

The metal of the fired layer includes, for example, at least one of Cu, Ni, Ag, Pd, an Ag—Pd alloy, Au, or the like.

The fired layer is formed by applying an electrically conductive paste including glass and metal to the first multilayer body 12 and firing the paste, and may be formed by co-firing the paste with the internal electrode layers 16, or may be formed by firing the paste after firing the internal electrode layers 16.

In a case in which a fired layer is provided as the first base electrode layer 32a and the second base electrode layer 32b, the thickness of the fired layer in the middle portion in the lamination direction x of each of the first base electrode layer 32a and the second base electrode layer 32b respectively located on the third surface 12c and the fourth surface 12d is preferably, for example, about 20 μm or more and about 50 μm or less.

In addition, in a case in which a fired layer is provided as the first base electrode layer 32a and the second base electrode layer 32b on the first surface 12a, the second surface 12b, the fifth surface 12e, and the sixth surface 12f, it is preferable that the thickness of the fired layer in the middle portion in the first direction y of each of the first base electrode layer 32a and the second base electrode layer 32b respectively located on the first surface 12a, the second surface 12b, the fifth surface 12e, and the sixth surface 12f is, for example, about 5 μm or more and about 20 μm or less.

In a case in which a fired layer is provided as the third base electrode layer 32c and the fourth base electrode layer 32d, the thickness of the fired layer in the middle portion in the lamination direction x of each of the third base electrode layer 32c and the fourth base electrode layer 32d respectively located on the fifth surface 12e and the sixth surface 12f is preferably, for example, about 20 μm or more and about 50 μm or less.

In addition, in a case in which a fired layer is provided as the third base electrode layer 32c and the fourth base electrode layer 32d on the first surface 12a and the second surface 12b, it is preferable that the thickness of the fired layer in the middle portion in the first direction y of each of the third base electrode layer 32c and the fourth base electrode layer 32d respectively located on the first surface 12a and the second surface 12b is, for example, about 5 μm or more and about 20 μm or less.

Next, a case where the base electrode layer 32 is formed with an electrically conductive resin layer will be described. The electrically conductive resin layer may be provided on the fired layer so as to cover the fired layer, or may be provided directly on the first multilayer body 12 without providing the fired layer. Further, the electrically conductive resin layer may completely cover the fired layer or may partially cover the fired layer. Further, the electrically conductive resin layer may include a plurality of layers.

The electrically conductive resin layer includes a thermosetting resin and a metal. Since the electrically conductive resin layer includes a thermosetting resin, the electrically conductive resin layer is more flexible than a fired layer made of, for example, a plated film or a fired product of an electrically conductive paste. For this reason, even when a physical impact or an impact due to a thermal cycle is applied to the multilayer ceramic capacitor 10, the electrically conductive resin layer functions as a buffer layer, so that cracks in the multilayer ceramic capacitor 10 can be prevented.

As the metal included in the electrically conductive resin layer, for example, Ag, Cu, Ni, Sn, Bi, or an alloy including one or more of them can be used. Alternatively, a metal powder obtained by coating the surface of the metal powder with, for example, Ag may be used. When an Ag-coated metal powder is used, for example, Cu, Ni, Sn, Bi or an alloy powder thereof is preferably used as the metal powder. The reason why the electrically conductive metal powder of Ag is used as the electrically conductive metal is that Ag is suitable for an electrode material because Ag has the lowest specific resistance among metals, and Ag is a noble metal, and thus has high weather resistance without being oxidized. The reason why the Ag-coated metal is used is that the metal of the base material can be made inexpensive, while maintaining the above-described characteristics of Ag.

The metal included in the electrically conductive resin layer mainly plays a role in the electrical conductivity of the electrically conductive resin layer. Specifically, the metals (conductive filler) included in the electrically conductive resin layer come into contact with each other to provide an electrical conduction path in the electrically conductive resin layer.

As the metal included in the electrically conductive resin layer, a metal having a spherical shape, a metal having a flat shape, or the like can be used, and it is preferable to use a mixture of a spherical metal powder and a flat metal powder. The average particle diameter of the metal included in the electrically conductive resin layer is not particularly limited. The average particle diameter of the metal (conductive filler) included in the electrically conductive resin layer may be, for example, about 0.3 μm or more and about 10 μm or less.

The metal included in the electrically conductive resin layer is, for example, preferably included in an amount of about 35 vol % or more and about 75 vol % or less with respect to the total volume of the electrically conductive resin.

As the resin of the electrically conductive resin layer, for example, various known thermosetting resins such as an epoxy resin, a phenol resin, a urethane resin, a silicone resin, and a polyimide resin can be used. Among them, an epoxy resin excellent in heat resistance, moisture resistance, adhesion, or the like is one of the more suitable resins.

The resin included in the electrically conductive resin layer is, for example, preferably included in an amount of about 25 vol % or more and about 65 vol % or less with respect to the total volume of the conductive resin.

The electrically conductive resin layer preferably includes a curing agent together with a thermosetting resin. When an epoxy resin is used as the base resin, various known compounds such as phenol-based, amine-based, acid anhydride-based, imidazole-based, active ester-based, and amide-imide-based compounds can be used as the curing agent of the epoxy resin.

In a case in which the electrically conductive resin electrode layer is provided as the first base electrode layer 32a and the second base electrode layer 32b, the thickness of the conductive resin electrode layer in the middle portion in the lamination direction x of each of the first base electrode layer 32a and the second base electrode layer 32b respectively located on the third surface 12c and the fourth surface 12d is preferably, for example, about 20 μm or more and about 70 μm or less.

Further, in a case in which the electrically conductive resin electrode layer is provided as the first base electrode layer 32a and the second base electrode layer 32b on the first surface 12a, the second surface 12b, the fifth surface 12e and the sixth surface 12f, it is preferable that the thickness of the electrically conductive resin electrode layer in the middle portion in the first direction y of each of the first base electrode layer 32a and the second base electrode layer 32b respectively located on the first surface 12a, the second surface 12b, the fifth surface 12e, and the sixth surface 12f is, for example, about 5 μm or more and about 20 μm or less.

In a case in which the electrically conductive resin electrode layer is provided as the third base electrode layer 32c and the fourth base electrode layer 32d, it is preferable that the thickness of the electrically conductive resin electrode layer in the middle portion in the lamination direction x of each of the third base electrode layer 32c and the fourth base electrode layer 32d respectively located on the fifth surface 12e and the sixth surface 12f is, for example, about 20 μm or more and about 70 μm or less.

Further, in a case in which the electrically conductive resin electrode layer is provided as the third base electrode layer 32c and the fourth base electrode layer 32d on the first surface 12a and the second surface 12b, it is preferable that the thickness of the electrically conductive resin electrode layer in the middle portion in the first direction y of each of the third base electrode layer 32c and the fourth base electrode layer 32d respectively located on the first surface 12a and the second surface 12b is, for example, about 5 μm or more and about 20 μm or less.

In addition, only the electrically conductive resin electrode layer may be provided as the first base electrode layer 32a and the second base electrode layer 32b, and only the electrically conductive resin electrode layer may be provided as the third base electrode layer 32c and the fourth base electrode layer 32d.

### Plated Layer

The plated layer 34 includes a first plated layer 34a, a second plated layer 34b, a third plated layer 34c, and a fourth plated layer 34d.

The first plated layer 34a is provided so as to cover the first base electrode layer 32a. The second plated layer 34b is provided so as to cover the second base electrode layer 32b. The third plated layer 34c is provided so as to cover the third base electrode layer 32c. The fourth plated layer 34d is provided so as to cover the fourth base electrode layer 32d.

The plated layer 34 includes, for example, at least one of Cu, Ni, Sn, Ag, Pd, Ag—Pd alloy, or Au, or the like.

The plated layer 34 may include a plurality of layers. The plated layer 34 preferably includes, for example, a two-layer structure in the order of Ni plating and Sn plating. The Ni plated layer can prevent the base electrode layer 32 from being eroded by solder when mounting the multilayer ceramic capacitor 10. In addition, the Sn plated layer improves the wettability of solder when mounting the multilayer ceramic capacitor 10, and thus can be easily mounted. When the plated layer 34 includes a three-layer structure, for example, it is preferable to include Sn plating, Ni plating, and Sn plating in this order from the first multilayer body 12.

The thickness of the plated layer 34 per layer is, for example, preferably about 1 μm or more and about 6 μm or less.

Any or each of the first external electrode 30a, the second external electrode 30b, the third external electrode 30c and the fourth external electrode 30d may include a plated layer provided directly on the surface of the first multilayer body 12. That is, the multilayer ceramic capacitor 10 may include a structure including a plated layer that is directly electrically connected to the first internal electrode layers 16a and the second internal electrode layers 16b. In such a case, a plated layer may be directly formed after the catalyst is provided on the surface of the first multilayer body 12 as a pretreatment.

The first direct plated layer is provided on the third surface 12c and is bonded to the first internal electrode layers 16a. The second direct plated layer is provided on the fourth surface 12d and is bonded to the first internal electrode layers 16a. The third direct plated layer is provided on the fifth surface 12e and is bonded to the second internal electrode layers 16b. The fourth direct plated layer is provided on the sixth surface 12f and is bonded to the second internal electrode layers 16b.

Each of the direct plated layers preferably includes, for example, at least one of Cu, Ni, Sn, Pb, Au, Ag, Pd, Bi, or Zn, or an alloy including the metal.

For example, in a case in which the first internal electrode layers 16a and the second internal electrode layers 16b are made using Ni, the direct plated layer is preferably made using Cu, which has a good bonding property with Ni.

In a case in which the plated layer 34 is directly formed on the first multilayer body 12, the thickness of the plated layer 34 per layer is, for example, preferably about 1 μm or more and about 15 μm or less.

In a case in which the plated layer 34 is directly provided on the first multilayer body 12, the plated layer 34 preferably does not include glass. Further, the metal ratio per unit volume of the plated layer 34 is, for example, preferably about 99% by volume or more.

A case where the base electrode layer 32 includes a thin film layer and the plated layer 34 is directly provided on the thin film layer will be described.

The first thin film layer provided on the first surface 12a is connected to the first direct plated layer which extends around from the third surface 12c. The second thin film layer provided on the first surface 12a is connected to the second direct plated layer, which extends around from the fourth surface 12d. The third thin film layer provided on the first surface 12a is connected to the third direct plated layer, which extends around from the fifth surface 12e. The fourth thin film layer provided on the first surface 12a is connected to the fourth direct plated layer, which extends around from the sixth surface 12f.

Similarly, the first thin film layer provided on the second surface 12b is connected to the first direct plated layer, which extends around from the third surface 12c. The second thin film layer provided on the second surface 12b is connected to the second direct plated layer, which extends around from the fourth surface 12d. The third thin film layer provided on the second surface 12b is connected to the third direct plated layer, which extends around from the fifth surface 12e. The fourth thin film layer provided on the second surface 12b is connected to the fourth direct plated layer, which extends around from the sixth surface 12f.

A dimension in the first direction y of the multilayer ceramic capacitor 10 including the first multilayer body 12 and the external electrode 30 is defined as an L dimension. The L dimension is, for example, preferably about 1.0 mm or more and about 3.2 mm or less. A dimension in the lamination direction x of the multilayer ceramic capacitor 10 including the first multilayer body 12 and the external electrode 30 is defined as a T dimension. The T dimension is, for example, preferably about 0.3 mm or more and about 2.5 mm or less. A dimension in the second direction z of the multilayer ceramic capacitor 10 including the first multilayer body 12 and the external electrode 30 is defined as a W dimension. The W dimension is, for example, preferably about 0.5 mm or more and about 2.5 mm or less.

### (b) Conductor Portion

Next, a conductor portion 40 will be described. As shown in FIG. 1, the conductor portion 40 is electrically connected to the first external electrode 30a and the second external electrode 30b of the multilayer ceramic capacitor 10 via an electrically conductive adhesive 70.

The conductor portion 40 can be configured as a chip-type coil component, for example.

The conductor portion 40 includes a second multilayer body 42 and a conductor electrode 60. Hereinafter, each configuration will be described in the order of the second multilayer body 42 and the conductor electrode 60.

The second multilayer body 42 includes a plurality of laminated ferrite layers 44. These ferrite layers 44 are integrally sintered in a laminated state. Further, the second multilayer body 42 includes a first surface 42a and a second surface 42b opposed to each other in the lamination direction x, a third surface 42c and a fourth surface 42d opposed to each other in the first direction y orthogonal or substantially orthogonal to the lamination direction x, and a fifth surface 42e and a sixth surface 42f opposed to each other in the second direction z orthogonal or substantially orthogonal to the lamination direction x and the first direction y. The second multilayer body 42 includes a rectangular parallelepiped shape. The second multilayer body 42 preferably includes rounded corner portions and ridge portions. In addition, each of the corner portions refers to a portion where three adjacent surfaces of the second multilayer body 42 intersect with each other, and each of the ridge portions refers to a portion where two adjacent surfaces of the second multilayer body 42 intersect with each other.

As shown in FIGS. 5 and 10, a coil 46 is provided inside the second multilayer body 42. The coil 46 is made of, for example, Cu or Ag. The coil 46 includes patterned conductors 48. Each of the patterned conductors 48 is provided on a corresponding one of the plurality of ferrite layers 44. Further, these patterned conductors 48 are connected in a coil shape by via holes 50 provided in the ferrite layers 44. One end portion of the coil 46 extends toward and is exposed on the third surface 42c of the second multilayer body 42 as a first extension conductor 52a. The other end of the coil 46 extends toward and is exposed on the fourth surface 42d of the second multilayer body 42 as a second extension conductor 52b. The coil 46 may be a conductive wire wound in a coil shape.

### Conductor Electrode

A conductor electrode 60 includes a first conductor electrode 60a and a second conductor electrode 60b. The conductor electrode 60 includes a conductor base electrode 62 and a conductor plated layer 64.

The first conductor electrode 60a is provided adjacent to the third surface 42c of the second multilayer body 42. The second conductor electrode 60b is provided adjacent to the fourth surface 42d of the second multilayer body 42.

The first conductor electrode 60a extends from the third surface 12c of the second multilayer body 42 to the first and second surfaces 42a and 42b and the fifth and sixth surfaces 42e and 42f. In this case, the first conductor electrode 60a is electrically connected to the first extension conductor 52a of the coil 46.

Further, the second conductor electrode 60b extends from the fourth surface 12d of the second multilayer body 42 to the first and second surfaces 42a and 42b and the fifth and sixth surfaces 42e and 42f. In this case, the second conductor electrode 60b is electrically connected to the second extension conductor 52b of the coil 46.

The first conductor electrode 60a includes a conductor base electrode 62 and a conductor plated layer 64a in order from the second multilayer body 42. The first conductor base electrode 62a is made of a conductor such as Ag or an Ag alloy, for example. Further, the first conductor base electrode 62a is provided on the surface of the second multilayer body 42, that is, on the third surface 12c or the like. In this case, the first conductor base electrode 62a is electrically connected to the first extension conductor 52a. The first conductor plated layer 64a includes a two-layer structure including, for example, a Ni plating film and a Sn plating film. The Ni plating film is provided on the first conductor base electrode 62a. The Sn plating film is provided on the Ni plating film.

Similarly to the first conductor electrode 60a, the second conductor electrode 60b includes a second conductor base electrode 62b and a conductor plated layer 64b in order from the second multilayer body 42. The second conductor base electrode 62b is made of a conductor such as, for example, Ag or an Ag alloy. The second conductor base electrode 62b is provided on the surface of the second multilayer body 42, that is, on the fourth surface 12d or the like. In this case, the second conductor base electrode 62b is electrically connected to the second extension conductor 52b. The second conductor plated layer 64b includes a two-layer structure including, for example, a Ni plating film and a Sn plating film. The Ni plating film is provided on the second conductor base electrode 62b. The Sn plating film is provided on the Ni plating film.

The first conductor electrode 60a is electrically connected to the first external electrode 30a via a first electrically conductive adhesive 70a. The second conductor electrode 60b is electrically connected to the second external electrode 30b via a second electrically conductive adhesive 70b.

More specifically, the first electrically conductive adhesive 70a is provided on the surface of the first conductor electrode 60a and extends from the first region 36a to the second region 36b in the first external electrode 30a. As a result, the first electrically conductive adhesive 70a is provided at the ridge portion formed by the first surface 12a and the third surface 12c of the first multilayer body 12. Further, the second electrically conductive adhesive 70b is provided on the second conductor electrode 60b and provided to span from the third region 36c to the fourth region 36d in the second external electrode 30b. As a result, the second electrically conductive adhesive 70b is provided at the ridge portion formed by the first surface 12a and the fourth surface 12d of the first multilayer body 12.

Here, as shown in FIG. 6A, in a cross section parallel or substantially parallel to the fifth surface 12e or the sixth surface 12f of the first multilayer body 12 and cut at a length of about one half of the dimension of the first multilayer body 12 in the second direction z, the total thickness t₃ (thickness of the ridge portion) of the thickness t₁ of the first external electrode 30a and the thickness t₂ of the first electrically conductive adhesive 70a along an extension line 11 of the first surface 12a in this cross section is, for example, about 7 μm or more. The total thickness t₃ (thickness of the ridge portion) is, for example, preferably about 12 μm or more, and more preferably about 62 μm or more.

Further, as shown in FIG. 6B, in a cross section parallel or substantially parallel to the fifth surface 12e or the sixth surface 12f of the first multilayer body 12 and cut at a length of one half of the dimension of the first multilayer body 12 in the second direction z, the total thickness to (thickness of the ridge portion) of the thickness t₄ of the second external electrode 30b and the thickness t₅ of the second electrically conductive adhesive 70b along an extension line 12 of the first surface 12a in this cross section is, for example, about 7 μm or more. The total thickness t₆ (thickness of the ridge portion) is, for example, preferably about 12 μm or more, and more preferably about 62 μm or more.

The electrically conductive adhesive 70 for use in connecting the conductor portion 140 and the multilayer ceramic capacitor 10 includes a metal component such as a high-temperature solder.

The electrically conductive adhesive 70 preferably includes voids. Thus, when the composite electronic component 1 is bent, the voids can define and function as a cushion portion.

When the direct current (DC) resistance of the multilayer ceramic capacitor 10 is defined as Rdc1 and the DC resistance of the conductor portion 40 is defined as Rdc2, Rdc2≤Rdc1 is satisfied.

When the DC resistance of the multilayer ceramic capacitor 10 is defined as Rdc1 and the DC resistance of the conductor portion 40 is defined as Rdc2, Rdc2≤Rdc1 is satisfied. As a result, an alternating current (AC) electrical current can be preferentially passed through the multilayer ceramic capacitor 10 having a low impedance, and a DC current can be passed through the side having a low DC resistance. In addition, since noise that has not flowed into the multilayer ceramic capacitor 10 can be removed by the conductor portion 40, which is a chip-type coil component, it is possible to improve the noise removal effect.

The DC resistance values of the conductor portion 40 and the multilayer ceramic capacitor 10 are measured after removing the electrically conductive adhesive 70 bonded thereto and removing them, and the DC resistance values are compared. The DC resistance values of the conductor portion 40 and the multilayer ceramic capacitor 10 are measured in accordance with JIS C2139 using a four-terminal method in which about 100 mA is supplied.

An insulating resin may be provided between the conductor portion 40 and the multilayer ceramic capacitor 10. At this time, the insulating resin preferably covers at least a portion of the multilayer ceramic capacitor 10. The insulating resin preferably covers at least a portion of the conductor portion 40. Further, the insulating resin preferably covers at least a portion of the multilayer ceramic capacitor 10 and at least a portion of the conductor portion 40.

### 2. Mounting Structure of Composite Electronic Component

Next, a mounting structure 500 of the composite electronic component 1 according to the first example embodiment of the present invention will be described.

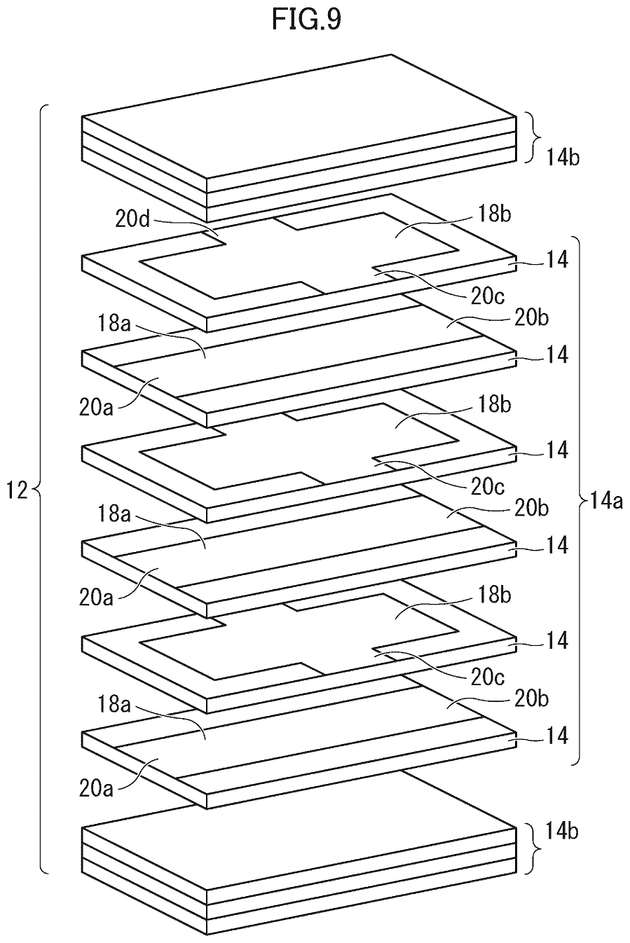

FIG. 11 is a cross-sectional view in a lamination direction showing the mounting structure of the composite electronic component according to the first example embodiment of the present invention. As shown in FIG. 11, the mounting structure 500 of the composite electronic component according to the present example embodiment includes the composite electronic component 1 and a mounting substrate 80 according to the present example embodiment. The mounting substrate 80 includes a core material 82 of the substrate and a connection conductor (conductor land) 84.

The core material 82 of the substrate is, for example, is obtained by impregnating a base material obtained by mixing a glass cloth and a glass nonwoven fabric with an epoxy resin or a polyimide resin, or a ceramic substrate manufactured by firing a sheet obtained by mixing ceramics and glass. The core material 82 of the substrate may include a single-layer substrate or a substrate including a plurality of laminated layers. The thickness of the core material 82 of the substrate is not particularly limited, but is preferably about 200 μm or more and about 800 μm or less, for example.

One main surface of the core material 82 of the substrate is provided with the conductor land 84 and defines a substrate-side mounting surface 82a defining and functioning as a mounting surface of the composite electronic component 1.

The conductor land 84 includes a first conductor land 84a, a second conductor land 84b, a third conductor land 84c, and a fourth conductor land 84d.

The first conductor land 84a is electrically connected to the first external electrode 30a of the multilayer ceramic capacitor 10 by a bonding material 86 and is mechanically bonded thereto. The second conductor land 84b is electrically connected to the second external electrode 30b of the multilayer ceramic capacitor 10 by the bonding material 86 and is mechanically bonded thereto. The third conductor land 84c is electrically connected to the third external electrode 30c of the multilayer ceramic capacitor 10 by the bonding material 86 and is mechanically bonded thereto. The fourth conductor land 84d is electrically connected to the fourth external electrode 30d of the multilayer ceramic capacitor 10 by the bonding material 86 and is mechanically bonded thereto.

The conductor land 84 may be provided on the main surface of the core material 82 of the substrate opposite to the substrate-side mounting surface 82a.

Although the material of the conductor land 84 is not particularly limited, for example, a metal such as Cu, Au, Pd, or Pt can be used. The thickness of each of the conductor lands 84, that is, the dimension in the lamination direction x is not particularly limited, but is preferably, for example, about 20 μm or more and about 200 μm or less. As the bonding material 86, for example, an epoxy-based adhesive for high heat resistance, or solder can be used.

In the above description, the mounting substrate 80 corresponds to the mounting substrate. The core material 82 of the substrate corresponds to the core material of the substrate. The substrate-side mounting surface 82a corresponds to the mounting surface. The plurality of conductor lands 84 corresponds to a plurality of connection conductors. However, the connection conductor is not limited to a land and is not limited by other applications, functions, shapes, names, etc., as long as the connection conductor is a conductor that is provided between the multilayer ceramic capacitor 10 and the mounting substrate 80 and can electrically connect them to each other.

In the composite electronic component mounting structure 500 shown in FIG. 11, the composite electronic component 1 is preferably mounted such that the conductor portion 40 of the composite electronic component 1 is provided in a direction opposite to the mounting substrate 80. That is, the conductor portion 40 of the composite electronic component 1 is preferably provided adjacent to the first surface (non-mounting surface) of the multilayer ceramic capacitor 10, and the multilayer ceramic capacitor 10 of the composite electronic component 1 is preferably mounted adjacent to the mounting substrate 80. By mounting them in this manner, the distance between the multilayer ceramic capacitor 10 and the mounting substrate 80 is not increased, such that the advantageous effect of low ESL can be easily obtained. In addition, the composite electronic component 1 can be mounted on the mounting substrate without affecting the mounting.

### 3. Method of Manufacturing Composite Electronic Component

Hereinafter, an example of a method of manufacturing the composite electronic component 1 according to the first example embodiment of the present invention will be described.

### (a) Method of Manufacturing Multilayer Ceramic Capacitor

First, an example of a method of manufacturing the multilayer ceramic capacitor 10 will be described. First, a dielectric sheet for manufacturing dielectric layers and an electrically conductive paste for manufacturing the internal electrode layers are prepared. The electrically conductive paste for manufacturing the dielectric sheet and the internal electrode layers includes a binder and a solvent. Known binders and solvents can be used.

Next, the electrically conductive paste for manufacturing the internal electrode layers is printed on the dielectric sheet in predetermined patterns by, for example, screen printing or gravure printing. Thus, the dielectric sheet on which the patterns of the first internal electrode layers 16a and the second internal electrode layers 16b are formed is prepared. More specifically, for example, a screen plate for printing the first internal electrode layers 16a and a screen plate for printing the second internal electrode layers 16b are separately prepared, and the internal electrode layers 16 of the present example embodiment can be printed using a printing machine capable of separately printing two types of screen plates. Here, in order to obtain a desired structure, the sheet on which the first internal electrode layer 16a is printed and the sheet on which the second internal electrode layer 16b is printed are laminated to form a portion defining and functioning as the inner layer portion 15a. In the present example embodiment, the internal electrode layer 16 is printed by screen printing, for example.

Next, by laminating a predetermined number of dielectric sheets on which the pattern of the internal electrode layer is not printed, a portion defining and functioning as the first outer layer portion 15b1 adjacent to the first surface 12a is formed. Thereafter, the portion defining and functioning as the inner layer portion 15a prepared above is laminated, and a predetermined number of dielectric sheets on which the pattern of the internal electrode layer is not printed are laminated on the portion defining and functioning as the inner layer portion 15a, such that a portion defining and functioning as the second outer layer portion 15b2 adjacent to the second surface 12b is formed. A multilayer sheet is manufactured with such a method.

Next, the multilayer sheet is pressed in the lamination direction by, for example, isostatic pressing or the like to produce a multilayer block.

Subsequently, the multilayer block is cut to a predetermined size to cut out multilayer chips. At this time, corner portions and ridge portions of the multilayer chips may be rounded by, for example, barrel polishing or the like.

Next, each of the multilayer chips is fired to produce the first multilayer body 12. The firing temperature depends on the materials of the dielectric layer 14 and the internal electrode layer 16, but is, for example, preferably about 900° C. or more and about 1400° C. or less.

The third base electrode layer 32c of the third external electrode 30c and the fourth base electrode layer 32d of the fourth external electrode 30d are respectively formed on the fifth surface 12e and the sixth surface 12f of the first multilayer body 12 obtained by firing.

In a case in which a fired layer is formed as the base electrode layer 32, an electrically conductive paste including a glass component and a metal component is applied, and then fired to form the base electrode layer 32. The temperature of the firing treatment at this time is, for example, preferably about 700° C. or more and about 900° C. or less. In the present example embodiment, the base electrode layer 32 is formed with a fired layer.

Here, as a method of forming the fired layer as the third base electrode layer 32c and the fourth base electrode layer 32d, various methods can be used. For example, the third base electrode layer 32c and the fourth base electrode layer 32d can be formed by a method in which an electrically conductive paste is applied by being extruded through slits. In this method, by increasing the extrusion amount of the electrically conductive paste, the third base electrode layer 32c and the fourth base electrode layer 32d can be formed not only on the fifth surface 12e and the sixth surface 12f, but also on a portion of the first surface 12a and a portion of the second surface 12b.

Alternatively, for example, a roller transfer method can be used. In the case of the roller transfer method, in a case in which the third base electrode layer 32c and the fourth base electrode layer 32d are formed not only on the fifth surface 12e and the sixth surface 12f, but also on a portion of the first surface 12a and a portion of the second surface 12b, the third base electrode layer 32c and the fourth base electrode layer 32d can be formed on a portion of the first surface 12a and a portion of the second surface 12b by increasing the pressing pressure during roller transfer.

Next, the first base electrode layer 32a of the first external electrode 30a and the second base electrode layer 32b of the second external electrode 30b are formed on the third surface 12c and the fourth surface 12d of the first multilayer body 12 obtained by firing. Similarly to the third base electrode layer 32c and the fourth base electrode layer 32d, in a case of forming a fired layer as the first base electrode layer 32a and the second base electrode layer 32b, an electrically conductive paste including a glass component and a metal component is applied, and then fired to form the first base electrode layer 32a and the second base electrode layer 32b. The temperature of the firing treatment at this time is, for example, preferably about 700° C. or more and about 900° C. or less.

Regarding the firing processing, the first base electrode layer 32a of the first external electrode 30a, the second base electrode layer 32b of the second external electrode 30b, the third base electrode layer 32c of the third external electrode 30c, and the fourth base electrode layer 32d of the fourth external electrode 30d may be simultaneously fired, or the third base electrode layer 32c of the third external electrode 30c and the fourth base electrode layer 32d of the fourth external electrode 30d on the lateral surface may be fired, and the first base electrode layer 32a of the first external electrode 30a and the second base electrode layer 32b of the second external electrode 30b on the end surface may be fired.

In a case in which the base electrode layer 32 is formed with an electrically conductive resin layer, the electrically conductive resin layer can be formed by the following example method. Further, the electrically conductive resin layer may be formed on the surface of the fired layer, or the electrically conductive resin layer may be formed directly on the first multilayer body 12 as a single body without forming the fired layer.

As a method of forming the electrically conductive resin layer, an electrically conductive resin paste including a thermosetting resin and a metal component is applied onto the fired layer or the first multilayer body 12, and heat treatment is performed at a temperature of, for example, about 250° C. or more and about 550° C. or less to thermally cure the resin, thus forming the electrically conductive resin layer. At this time, the atmosphere during the heat treatment is, for example, preferably an N° atmosphere. Further, in order to prevent scattering of the resin and oxidation of various metal components, the oxygen concentration is, for example, preferably reduced to about 100 ppm or less.

As an example of a method of applying the electrically conductive resin paste, for example, a method of applying the electrically conductive resin paste by extruding the electrically conductive resin paste through a slit or a roller transfer method can be used in the same or substantially the same manner as the method of forming the base electrode layer 32 with the fired layer.

In a case in which the base electrode layer 32 is formed with a thin film layer, masking or the like is performed, and the base electrode layer 32 can be formed by a thin film formation method such as, for example, a sputtering method or a vapor deposition method at a portion where the base electrode layer 32 is desired to be formed. The base electrode layer 32 formed with a thin film layer is a layer having a thickness of, for example, about 1 μm or less on which metal particles are deposited.

Finally, the plated layer 34 is formed. The plated layer 34 may be formed on the surface of the base electrode layer 32, or may be formed directly on the first multilayer body 12. In the present example embodiment, the plated layer 34 is formed on the surface of the base electrode layer 32. More specifically, for example, a Ni plated layer and a Sn plated layer are formed on the base electrode layer 32. In a case in which plating is performed, for example, either electrolytic plating or electroless plating may be used. However, electroless plating requires pretreatment with a catalyst or the like in order to improve the plating deposition rate, and has a disadvantage in that the processing becomes complicated. Therefore, in general, electrolytic plating is preferably used.

As described above, the multilayer ceramic capacitor 10 shown in FIG. 1 can be manufactured.

### (b) Method of Manufacturing Conductor Portion

Next, an example of a method of manufacturing the conductor portion 40, which is a chip-type coil component, will be described.

First, a step of preparing a ceramic base body will be described. For example, a material obtained by weighing ferric oxide (Fe₂O₃), zinc oxide (ZnO), nickel oxide (NiO), and copper oxide (CuO) at predetermined ratios is charged into a ball mill as a raw material, and wet blending is performed for a predetermined time to obtain a mixture. The powder obtained by drying and pulverizing the mixture is calcined at, for example, about 700° C. for about 1 hour to obtain a calcined powder. The calcined powder is subjected to wet pulverization for a predetermined time using a ball mill, and then dried and crushed to obtain ferrite powder.

A binder resin, a plasticizer, a wetting agent, and a dispersant are added to the ferrite powder, and the mixture is mixed with a ball mill for a predetermined time, and then defoaming is performed under reduced pressure to obtain a slurry. The slurry is applied onto a film having releasability using, for example, a lip coater or a multicoater, and dried to obtain a long ferrite green sheet having a desired film thickness.

The long ferrite green sheet is cut to a predetermined size, and a via hole is formed by a method such as, for example, laser processing to obtain a ferrite sheet having a via hole at a predetermined position. A conductive paste including Ag or an Ag alloy as a main component is applied onto the ferrite sheet in a predetermined pattern by a method such as, for example, screen printing, and dried by heating to obtain electrode-formed ferrite sheets, each having a coil conductor.

The electrode-formed ferrite sheets are laminated so that the coil conductors are interlayer-connected to form a coil, thus forming a multilayer body, and ferrite green sheets to which no conductor paste is applied are laminated on and under the multilayer body to obtain an unfired multilayer body. When the electrode-formed ferrite sheets each including the coil conductor are laminated, the coil conductors are interlayer-connected in a coil shape via the via holes described above, and the coil is formed inside the unfired multilayer body.

Then, the unfired multilayer body is pressure-bonded at a pressure of about 1.0 t/cm² at, for example, 45° C. to obtain a multilayer pressure-bonded body. Then, the multilayer pressure-bonded body is cut to a predetermined size by a method such as, for example, dicing with a dicer or cutting with a push-cutting blade to obtain an unfired ceramic base body.

Next, the unfired ceramic base body is subject to de-binding under predetermined conditions, and then fired. The de-binding is performed, for example, in a low oxygen atmosphere at about 500° C. for about 2 hours. The firing is performed, for example, in an air atmosphere at about 870° C. for about 150 minutes. Thus, the second multilayer body 42 (see FIG. 10) is formed. The second multilayer body 42 includes the plurality of ferrite layers 44. These ferrite layers 44 are integrally sintered in a laminated state. The coil 46 is formed inside the second multilayer body 42. The coil 46 includes the respective patterned conductors 48. Each of the patterned conductors 48 is formed on a corresponding one of the ferrite layers 44. The respective patterned conductors 48 are connected in a coil shape by the via holes 50.

Next, a step of forming the conductor electrode will be described. First, an electrode material paste for forming an external electrode is applied by an immersion method to the third surface 42c and the fourth surface 42d of the second multilayer body 42 from which the extension conductors 52a and 52b of the coil 46 are exposed, dried, for example, at about 120° C. for about 10 minutes, and then fired at about 800° C. for about 15 minutes to form the conductor base electrodes 62a and 62b of the conductor electrodes 60a and 60b.

Then, on the conductor base electrodes 62a and 62b of the conductor electrodes 60a and 60b, conductor plated layers 64a and 64b having a two-layer structure in which the lower layer is a Ni plated film and the upper layer is a Sn plated film are formed. Thus, the conductor portion 40 shown in FIG. 1 is obtained.

### (c) Method of Manufacturing Composite Electronic Component

Next, the conductor portion 40 manufactured by the above-described method is mounted on the multilayer ceramic capacitor 10 manufactured by the above-described method.

More specifically, a cutting support tape is attached to an assembly of the conductor portions 40. Next, the assembly of the conductor portions 40 is cut into pieces of a predetermined size. Next, the cut and separated conductor portions 40 are transferred to the heat-resistant plate. At the time of transfer, a heat-resistant tape, an adhesive, or the like may be provided on the heat-resistant plate. Subsequently, the electrically conductive adhesive 70 (solder) is printed on the conductor portions 40 which are transferred, and cut and separated, and the multilayer ceramic capacitor 10 is mounted by a mounter.

Next, soldering is performed in a reflow furnace. Finally, the cut and separated conductor portions 40 are removed from the heat-resistant plate, and the flux is washed.

As described above, the composite electronic component 1 shown in FIG. 1 is manufactured.

### B. Second Example Embodiment

In a composite electronic component 1A according to a second example embodiment of the present invention, the conductor portion 40, which is a chip-type coil component in the composite electronic component 1 of the first example embodiment, is also configured as, for example, an interposer substrate as the conductor portion 140.

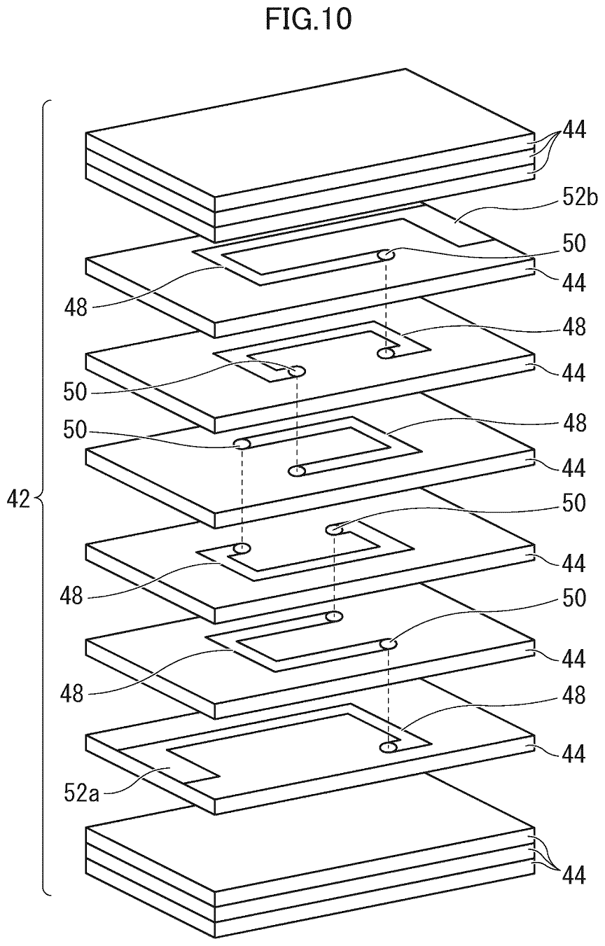

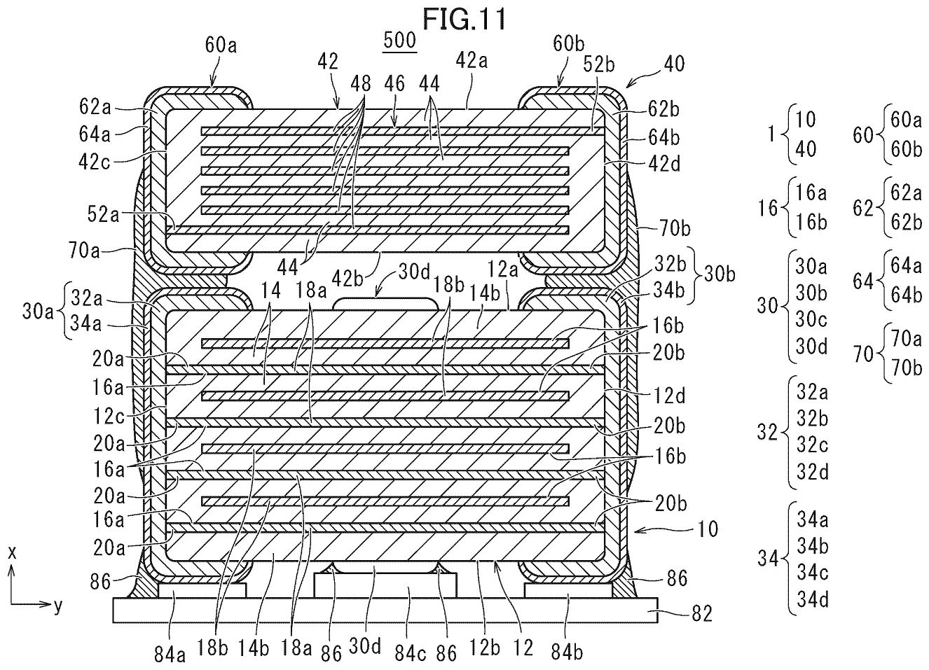

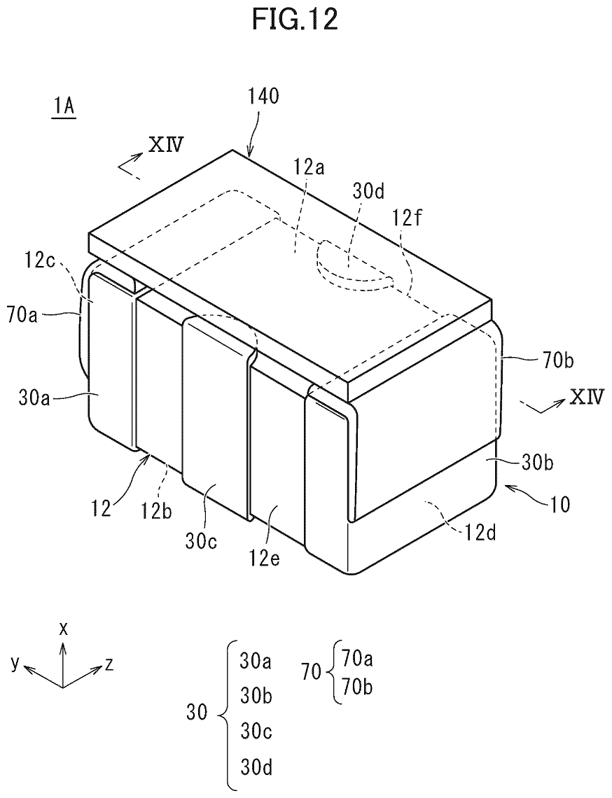

FIG. 12 is an external perspective view showing a composite electronic component according to the second example embodiment of the present invention. FIG. 13 is a front view of a composite electronic component according to the second example embodiment of the present invention. FIG. 14 is a cross-sectional view taken along the line XIV-XIV of FIG. 12.

As shown in FIGS. 12 and 13, the composite electronic component 1A according to the second example embodiment of the present invention includes the multilayer ceramic capacitor 10 and the conductor portion 140.

Since the multilayer ceramic capacitor 10 included in the composite electronic component 1A according to the second example embodiment is the same or substantially the same as the multilayer ceramic capacitor 10 included in the composite electronic component 1 according to the first example embodiment, a description thereof will be omitted.

### 1. Conductor Portion

Next, the conductor portion 140 will be described.

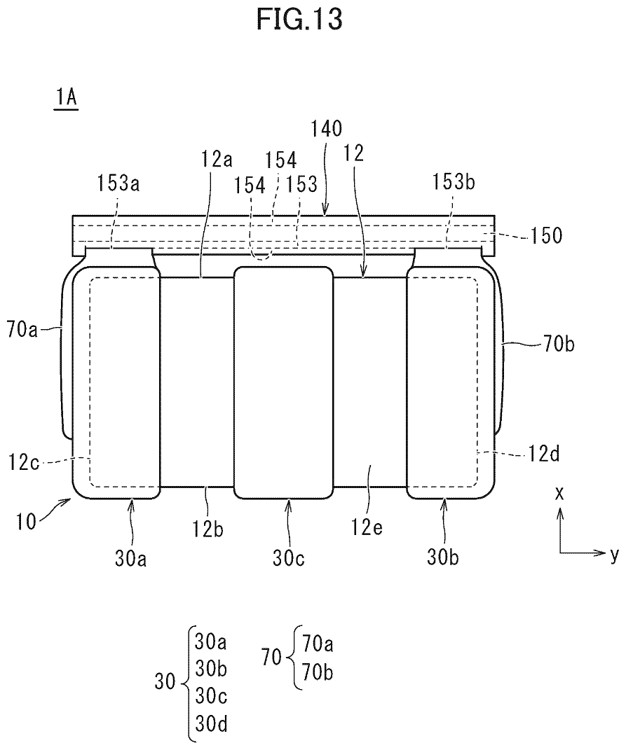

FIG. 15 is a cross-sectional view illustrating an example of a conductor portion. The conductor portion 140 is, for example, a single-sided substrate. Specifically, the conductor portion 140 includes an insulating substrate 150 and an electrically conductive pattern 152 provided on one main surface of the insulating substrate 150. A protective layer 154 is provided on the surface of the electrically conductive pattern 152 so as to expose a portion of the electrically conductive pattern 152. The exposed portion of the conductive pattern 152 is a pair of exposed electrode portions 153a and 153b. Further, another protective layer 154 is provided on the entire surface of the other main surface of the insulating substrate 150. The protective layer 154 may not be provided on the other main surface of the insulating substrate 150.

The exposed electrode portion 153a is electrically connected to the first external electrode 30a via the first electrically conductive adhesive 70a. The exposed electrode portion 153b is electrically connected to the second external electrode 30b via the second electrically conductive adhesive 70b.

More specifically, the first electrically conductive adhesive 70a is provided on the exposed electrode portion 153a and extends from the first region 36a to the second region 36b of the first external electrode 30a. As a result, the first electrically conductive adhesive 70a is provided at the ridge portion formed by the first surface 12a and the third surface 12c of the first multilayer body 12. In addition, the second electrically conductive adhesive 70b is provided on the exposed electrode portion 153b and extends from the third region 36c to the fourth region 36d of the second external electrode 30b. As a result, the second electrically conductive adhesive 70b is provided at the ridge portion formed by the first surface 12a and the fourth surface 12d of the first multilayer body 12.

The conductor portion 140 may have a rectangular or substantially rectangular shape or a disc shape, and the shape thereof is not limited. However, in a case in which the conductor portion 140 is provided on the first surface 12a or the second surface 12b, when the thickness of the conductor portion 140 in the lamination direction x is increased, the dimension of the composite electronic component 1A in the lamination direction x increases. Therefore, in a case in which the conductor portion 140 is provided on the first surface 12a or the second surface 12b of the composite electronic component 1A, it is preferable to reduce the thickness of the conductor portion 140.

### 2. Modification of Conductor Portion

The conductor portion 140 includes a single-sided substrate as the interposer substrate as described above, but may include a double-sided substrate or a multilayer substrate. Hereinafter, modifications of the conductor portion 140 will be described.

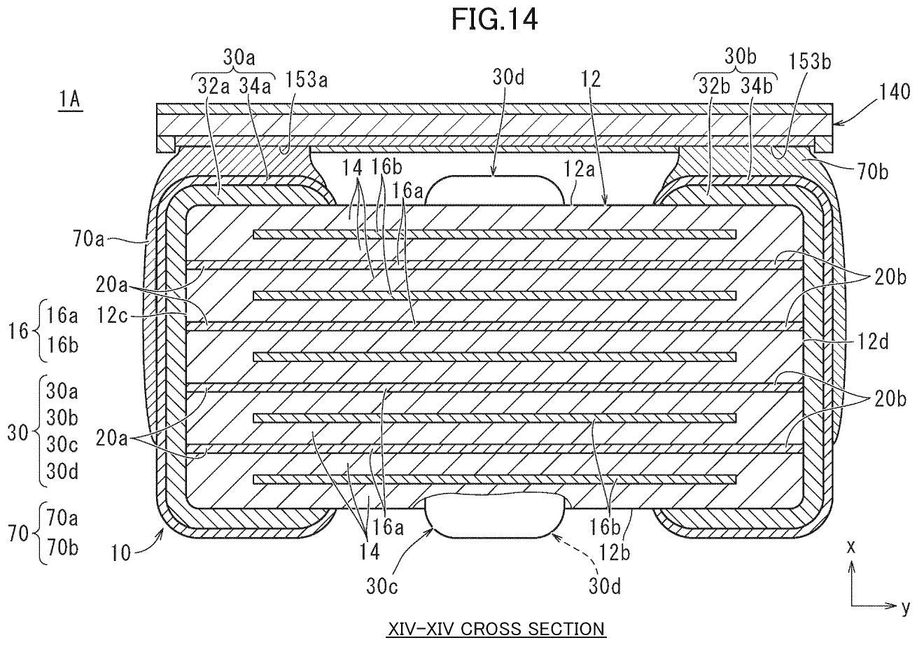

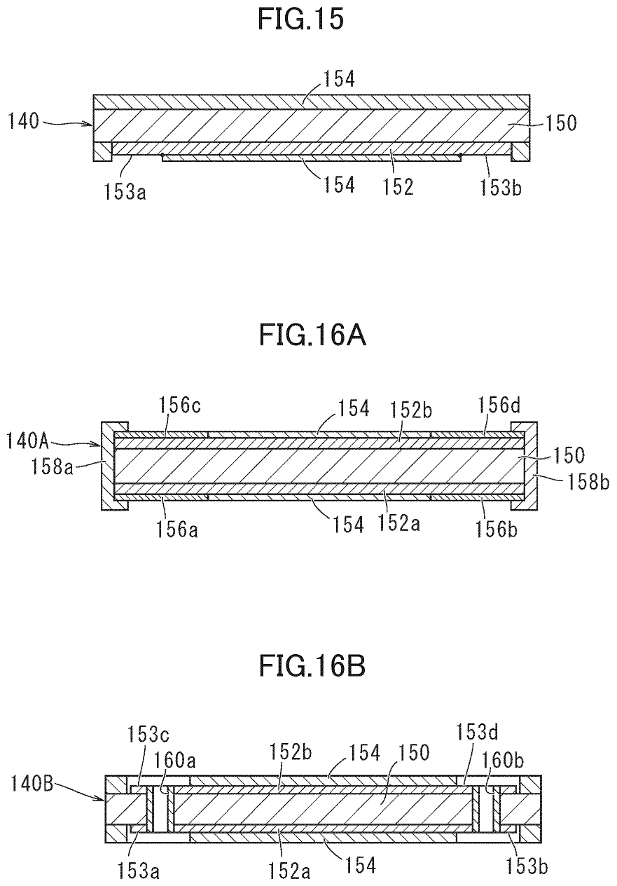

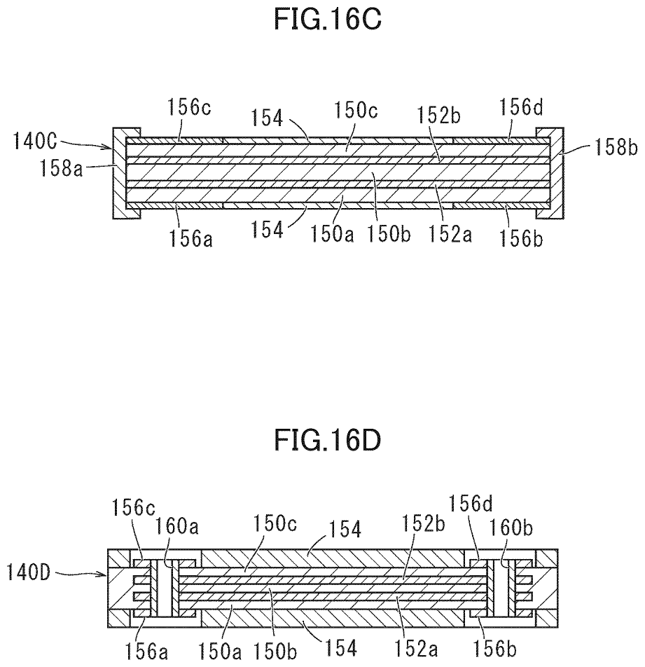

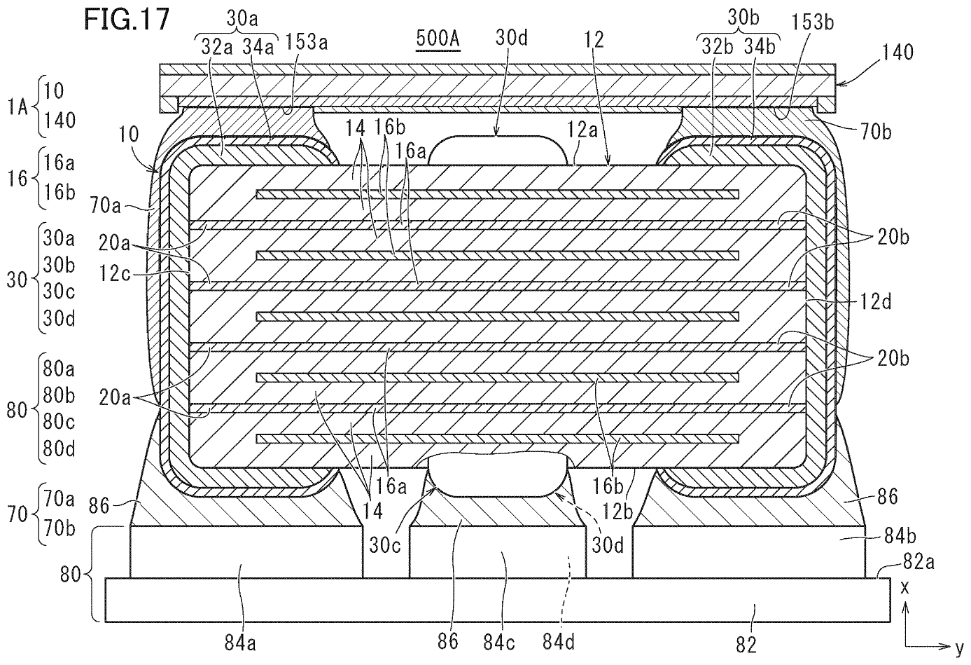

A conductor portion 140A, which is a first modification of the conductor portion 140, will be described. FIG. 16a is a cross-sectional view illustrating the first modification of the conductor portion 140. The conductor portion 140A is a double-sided substrate. Specifically, the conductor portion 140A includes the insulating substrate 150, an electrically conductive pattern 152a provided on one main surface of the insulating substrate 150, and an electrically conductive pattern 152b provided on the other main surface of the insulating substrate 150. A land electrode portion 156a is provided on the surface of the electrically conductive pattern 152a on the one end side of the insulating substrate 150, and a land electrode portion 156b is provided on the surface of the electrically conductive pattern 152a on the other end side of the insulating substrate 150. On the one main surface of the insulating substrate 150, the protective layer 154 is provided on a portion of the electrically conductive pattern 152a where the land electrode portions 156a and 156b are not provided. The land electrode portion 156c is provided on the surface of the electrically conductive pattern 152b on the one end side of the insulating substrate 150, and the land electrode portion 156d is provided on the surface of the electrically conductive pattern 152b on the other end side of the insulating substrate 150. On the other main surface of the insulating substrate 150, the protective layer 154 is provided on a portion of the electrically conductive pattern 152b where the land electrode portions 156c and 156d are not provided. An interlayer connection conductor (end surface through hole) 158a to electrically connect the land electrode portion 156a and the land electrode portion 156c is provided on one end side of the insulating substrate 150. An interlayer connection conductor (end surface through hole) 158b to electrically connect the land electrode portion 156b and the land electrode portion 156d is provided on the other end side of the insulating substrate 150.

The land electrode portion 156a is electrically connected to the first external electrode 30a via the first electrically conductive adhesive 70a. The land electrode portion 156b is electrically connected to the second external electrode 30b via the second electrically conductive adhesive 70b.

Next, a conductor portion 140B, which is a second modification of the conductor portion 140, will be described. FIG. 16B is a cross-sectional view illustrating a second modification of the conductor portion. The conductor portion 140B is a double-sided substrate. Specifically, the conductor portion 140B includes an insulating substrate 150, an electrically conductive pattern 152a provided on one main surface of the insulating substrate 150, and an electrically conductive pattern 152b provided on the other main surface of the insulating substrate 150. A protective layer 154 is provided on the surface of the electrically conductive pattern 152a so as to expose a portion of the electrically conductive pattern 152a. The exposed portion of the conductive pattern 152a is a pair of exposed electrode portions 153a and 153b. The protective layer 154 is provided on the surface of the electrically conductive pattern 152b so as to expose a portion of the conductive pattern 152b. The exposed portion of the conductive pattern 152b is a pair of exposed electrode portions 153c and 153d. In order to provide electrical conduction between the exposed electrode portion 153a and the exposed electrode portion 153c, an interlayer connection conductor (through hole) 160a that penetrates the insulating substrate 150 from one main surface to the other main surface is provided. In order to provided electrical conduction between the exposed electrode portion 153b and the exposed electrode portion 153d, an interlayer connection conductor (through hole) 160b that penetrates the insulating substrate 150 from one main surface to the other main surface is provided.

The exposed electrode portion 153a is electrically connected to the first external electrode 30a via the first electrically conductive adhesive 70a. The exposed electrode portion 153b is electrically connected to the second external electrode 30b via the second electrically conductive adhesive 70b.

Next, a conductor portion 140C, which is a third modification of the conductor portion 140, will be described. FIG. 16C is a cross-sectional view showing a third modification of the conductor portion. The conductor portion 140C is a multilayer substrate. Specifically, the conductor portion 140C includes a plurality of insulating substrates 150a to 150c and electrically conductive patterns 152a and 152b. The electrically conductive patterns 152a and 152b are alternately provided with a corresponding one of the insulating substrates 150a to 150c interposed therebetween. The electrically conductive patterns 152a and 152b may be exposed from both end surfaces of the insulating substrates 150a to 150c. A land electrode portion 156a is provided on a surface on one end side of the insulating substrate 150a located on one main surface side of the conductor portion 140C, and a land electrode portion 156b is provided on a surface on the other end side of the insulating substrate 150a located on the one main surface side of the conductor portion 140C. On the surface of the insulating substrate 150a, the protective layer 154 is provided at a portion where the land electrode portions 156a and 156b are not provided. A land electrode portion 156c is provided on the surface on the one end side of the insulating substrate 150c located on the other main surface side of the conductor portion 140C, and a land electrode portion 156d is provided on the surface on the other end side of the insulating substrate 150c located on the other main surface side of the conductor portion 140C. On the surface of the insulating substrate 150c, the protective layer 154 is provided at a portion where the land electrode portions 156c and 156d are not provided. An interlayer connection conductor (end surface through hole) 158a to electrically connect the land electrode portion 156a and the land electrode portion 156c is provided on one end side of the insulating substrates 150a to 150c. At this time, the interlayer connection conductor 158a is also electrically connected to the electrically conductive patterns 152a and 152b. An interlayer connection conductor (end surface through hole) 158b to electrically connect the land electrode portion 156b and the land electrode portion 156d is provided on the other end side of the insulating substrates 150a to 150c. At this time, the interlayer connection conductor 158b is also electrically connected to the electrically conductive patterns 152a and 152b.

The land electrode portion 156a is electrically connected to the first external electrode 30a via the first electrically conductive adhesive 70a. The land electrode portion 156b is electrically connected to the second external electrode 30b via the second electrically conductive adhesive 70b.

Next, a conductor portion 140D, which is a fourth modification of the conductor portion 140, will be described. FIG. 16D is a cross-sectional view illustrating a fourth modification of the conductor portion. The conductor portion 140D is a multilayer substrate. Specifically, the conductor portion 140D includes a plurality of insulating substrates 150a to 150c and electrically conductive patterns 152a and 152b. The electrically conductive patterns 152a and 152b are alternately provided with a corresponding one of the insulating substrates 150a to 150c interposed therebetween. The protective layer 154 is provided on the surface of the insulating substrate 150a located on the one main surface side of the conductor portion 140D so as to expose a portion of the insulating substrate 150a. A pair of land electrode portions 156a and 156b are provided on the exposed portion of the insulating substrate 150a. The protective layer 154 is provided on the surface of the insulating substrate 150c located on the other main surface side of the conductor portion 140D so as to expose a portion of the insulating substrate 150c. A pair of land electrode portions 156c and 156d are provided on the exposed portion of the insulating substrate 150c. In order to provide electrical conduction between the land electrode portion 156a and the land electrode portion 156c, an interlayer connection conductor (through hole) 160a that penetrates from the surface of the insulating substrate 150a to the surface of the insulating substrate 150c is provided. At this time, the interlayer connection conductor 160a is also electrically connected to the electrically conductive patterns 152a and 152b. In order to provide electrical conduction between the land electrode portion 156b and the land electrode portion 156d, an interlayer connection conductor (through hole) that penetrates from the surface of the insulating substrate 150a to the surface of the insulating substrate 150c is provided. At this time, the interlayer connection conductor 160b is also electrically connected to the electrically conductive patterns 152a and 152b.

The land electrode portion 156a is electrically connected to the first external electrode 30a via the first electrically conductive adhesive 70a. The land electrode portion 156b is electrically connected to the second external electrode 30b via the second electrically conductive adhesive 70b.

The insulating substrates 150 and 150a to 150c are made of, for example, a substrate made of a material obtained by impregnating a base material obtained by mixing a glass cloth and a glass nonwoven fabric with an epoxy resin or a polyimide resin, or a ceramic substrate manufactured by firing a sheet obtained by mixing ceramics and glass. In addition, the insulating substrates 150 and 150a to 150c may include a single layer or may include a plurality of laminated layers. The thickness of the insulating substrates 150 and 150a to 150c is not particularly limited, but is preferably about 200 μm or more and about 800 μm or less, for example.

The material of the electrically conductive patterns 152, 152a, and 152b is not particularly limited and, for example, a metal such as Cu, Au, Pd, or Pt may be used. In addition, the thickness of the electrically conductive patterns 152, 152a, and 152b, that is, the dimension in the lamination direction x, is not particularly limited, but is preferably, for example, about 20 μm or more and about 200 μm or less.

The electrically conductive adhesive 70 used to connect the conductor portion 140 and the multilayer ceramic capacitor 10 includes a metal component such as a high-temperature solder, for example.

As described above, the electrically conductive adhesive 70 is provided such that the conductor portion 140 is electrically connected to the first external electrode 30a and the second external electrode 30b of the multilayer ceramic capacitor 10. In other words, the conductor portion 140 is electrically connected to the first external electrode 30a and the second external electrode 30b of the multilayer ceramic capacitor 10 via the electrically conductive adhesive 70. As described above, by providing the conductor portion 140 so as to be electrically connected to the first external electrode 30a and the second external electrode 30b of the multilayer ceramic capacitor 10, the DC current flows through the conductor portion 140, such that it is possible to reduce or prevent the electric current flowing through the multilayer ceramic capacitor 10, and it is possible to reduce or prevent a temperature rise.

When the DC resistance of the multilayer ceramic capacitor 10 is defined as Rdc1 and the DC resistance of the conductor portion 140 is defined as Rdc2, Rdc2≤Rdc1 is satisfied.

Since the DC resistance Rdc2 of the conductor portion 140 is equal to or less than the DC resistance Rdc1 of the multilayer ceramic capacitor 10, the DC current more preferentially flows into the conductor portion 140, and the electric current flowing through the multilayer ceramic capacitor 10 is reduced, such that it is possible to reduce or prevent a temperature rise as an advantageous effect.

On the other hand, when the DC resistance Rdc2 of the conductor portion 140 is larger than the DC resistance Rdc1 of the multilayer ceramic capacitor 10, an electric current flows through the multilayer ceramic capacitor 10 more than the conductor portion 140, and thus it is difficult to obtain an advantageous effect of handling a large electric current.

The conductor portion 140 is not electrically connected to the third external electrode 30c and the fourth external electrode 30d. By providing the conductor portion 140 so as to be electrically connected only to the first external electrode 30a and the second external electrode 30b of the multilayer ceramic capacitor 10, the DC current flows through the conductor portion 140, and an electric current flowing through the multilayer ceramic capacitor 10 is reduced, such that it is possible to reduce or prevent a temperature rise.

The DC resistance values of the conductor portion 140 and the multilayer ceramic capacitor 10 are measured after removing the electrically conductive adhesive 70 bonded thereto and removing them, and the DC resistance values are compared. The DC resistance values of the conductor portion 140 and the multilayer ceramic capacitor 10 are measured in accordance with JIS C2139 using the four-terminal method applying about 100 mA.

According to the composite electronic component 1A shown in FIG. 12, the DC resistance Rdc2 of the conductor portion 140 connected to the multilayer ceramic capacitor 10 is equal to or less than the DC resistance Rdc1 of the multilayer ceramic capacitor 10. This allows the DC current to flow through the conductor portion and allows the AC current to escape to the multilayer ceramic capacitor 10. More specifically, since the DC current is likely to flow to the side having a lower DC resistance, the DC current is likely to flow to the conductor portion 140 having a lower DC resistance than the multilayer ceramic capacitor 10. On the other hand, since the AC current is likely to flow toward the side having a low impedance, the AC current is likely to flow toward the multilayer ceramic capacitor 10 having the low impedance. With such a configuration, it is possible to increase the capacitance of the multilayer ceramic capacitor 10 and reduce or prevent an increase in DC resistance. Further, it is possible to handle a large electric current by simply attaching the conductor portion 40 to the existing multilayer ceramic capacitor 10, without newly designing an internal structure uniquely for each capacitance of the multilayer ceramic capacitor 10. This also increases the development of the product lineup.

### 3. Mounting Structure of Composite Electronic Component

Next, a mounting structure 500A of the composite electronic component 1A according to the second example embodiment of the present invention will be described.

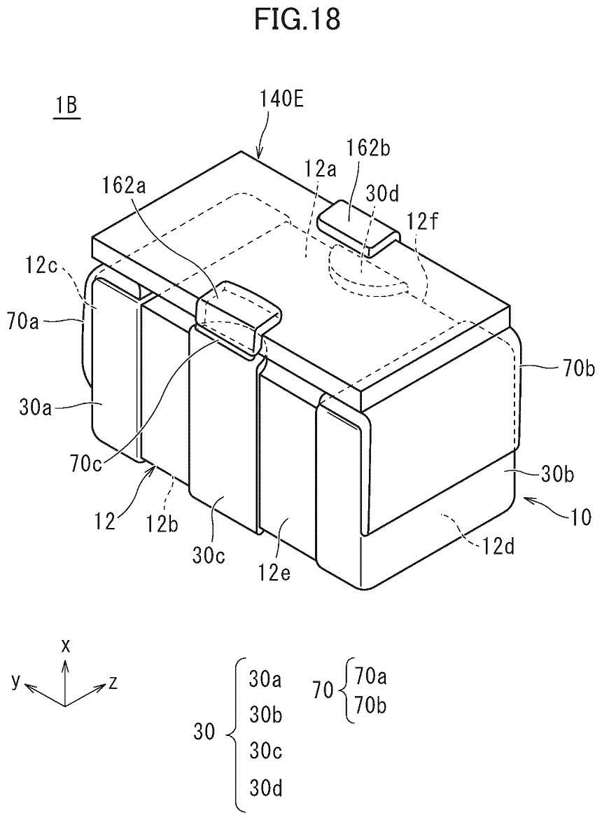

FIG. 17 is a cross-sectional view in the lamination direction showing a mounting structure of the composite electronic component 1A according to the second example embodiment of the present invention.

As shown in FIGS. 12 and 13, the mounting structure 500A of the composite electronic component according to the second example embodiment includes the composite electronic component 1 according to the second example embodiment and the mounting substrate 80. The mounting substrate 80 includes the core material 82 of the substrate and the connection conductor 84 (conductor land).

The core material 82 of the substrate is, for example, a substrate made of a material obtained by impregnating a base material obtained by mixing a glass cloth and a glass nonwoven fabric with an epoxy resin or a polyimide resin, or a ceramic substrate manufactured by firing a sheet obtained by mixing ceramics and glass. The core material 82 of the substrate may be a single-layer substrate or a substrate including a plurality of laminated layers. The thickness of the core material 82 of the substrate is not particularly limited, but is preferably about 200 μm or more and about 800 μm or less, for example.

One main surface of the core material 82 of the substrate is provided with the conductor land 84 and defines a substrate-side mounting surface 82a defining and functioning as a mounting surface of the composite electronic component 1.

The conductor land 84 includes the first conductor land 84a, the second conductor land 84b, the third conductor land 84c, and the fourth conductor land 84d.

The first conductor land 84a is electrically connected to the first external electrode 30a of the multilayer ceramic capacitor 10 by the bonding material 86 and is mechanically bonded thereto. The second conductor land 84b is electrically connected to the second external electrode 30b of the multilayer ceramic capacitor 10 by the bonding material 86 and is mechanically bonded thereto. The third conductor land 84c is electrically connected to the third external electrode 30c of the multilayer ceramic capacitor 10 by the bonding material 86 and is mechanically bonded thereto. The fourth conductor land 84d is electrically connected to the fourth external electrode 30d of the multilayer ceramic capacitor 10 by the bonding material 86 and is mechanically bonded thereto.

In addition, the conductor land 84 may be provided on the main surface of the core material 82 of the substrate opposite to the substrate-side mounting surface 82a.

Although the material of the conductor land 84 is not particularly limited, for example, a metal such as Cu, Au, Pd, or Pt can be used. The thickness of the conductor land 84, that is, the dimension in the lamination direction x, is not particularly limited, but is preferably, for example, about 20 μm or more and about 200 μm or less. As the bonding material 86, for example, an epoxy-based adhesive for high heat resistance or solder can be used.

In the above description, the mounting substrate 80 corresponds to the mounting substrate. The core material 82 of the substrate corresponds to the core material of the substrate. The substrate-side mounting surface 82a corresponds to the mounting surface. The plurality of conductor lands 84 corresponds to a plurality of connection conductors. However, the connection conductor is not limited to a land and is not limited by other applications, functions, shapes, names, etc., as long as the connection conductor is a conductor that is provided between the multilayer ceramic capacitor 10 and the mounting substrate 80 and can electrically connect them to each other.

In the mounting structure 500A of the composite electronic component shown in FIG. 17, the composite electronic component 1A is preferably mounted such that the conductor portion 140 of the composite electronic component 1A is provided in a direction opposite to the mounting substrate 80. That is, the conductor portion 140 of the composite electronic component 1A is preferably provided adjacent to the first surface (non-mounting surface) of the multilayer ceramic capacitor 10, and the multilayer ceramic capacitor 10 of the composite electronic component 1A is preferably mounted adjacent to the mounting substrate 80. By mounting them in this manner, the distance between the multilayer ceramic capacitor 10 and the mounting substrate 80 is not increased, such that low ESL can be easily obtained. In addition, the composite electronic component 1A can be mounted on the mounting substrate without affecting the mounting.

### 4. Method of Manufacturing Composite Electronic Component

Hereinafter, an example of a method of manufacturing the composite electronic component 1A according to the second example embodiment of the present invention will be described.

### (a) Method of Manufacturing Multilayer Ceramic Capacitor

Since the example method of manufacturing the multilayer ceramic capacitor 10 is the same or substantially the same as that of the multilayer ceramic capacitor 10 of the first example embodiment, a description thereof will be omitted.

### (b) Method of Manufacturing Conductor Portion

Next, an example of a method of manufacturing the conductor portion 140 of the composite electronic component 1A according to the second example embodiment of the present invention will be described.

The conductor portion 140 can be manufactured by first manufacturing an assembly of the conductor portions 140, and cutting the assembly of the conductor portions 140 into pieces.

The assembly of the conductor portions 140 is manufactured by a method the same as or similar to that of manufacturing a general printed circuit board.

The conductor portion 140, which is a single-sided substrate, is manufactured as follows. First, a material in which a copper foil is provided on one main surface of an insulating substrate is prepared, and the material is cut into a predetermined size. Next, an etching resist is printed on a portion (for example, an electrically conductive pattern) where the copper foil remains. Next, the copper foil other than the portion to which the etching resist is applied is removed by etching. Thereafter, the etching resist in the remaining portion is removed to form an electrically conductive pattern. Next, a solder resist is printed and UV-cured to form a protective layer in order to prevent solder from adhering to unnecessary portions in the insulating step of insulating between the electrically conductive patterns and the soldering step. Finally, a surface treatment such as solder plating, electroless gold plating, or water-soluble flux treatment is performed on the exposed electrode portion, which is a portion where the electrically conductive pattern is exposed, for the purpose of improving solderability and preventing corrosion of the copper foil portion. Thus, the assembly of the conductor portions 140, which is a single-sided substrate, is manufactured.

The conductor portion 140B, which is an example of a double-sided substrate, is manufactured as follows. First, a material in which copper foils are provided on both main surfaces of an insulating substrate is prepared, and the material is cut to a predetermined size. Next, hole forming processing for forming a through hole, a via hole, etc., is performed at a predetermined position of the cut material. Next, in order to electrically connect the copper foil surfaces provided on both main surfaces of the insulating base material, interlayer connection conductors (through holes) are formed by through-hole plating. Next, dry films (etching resist) are laminated on both main surfaces of the insulating substrate. Next, exposure and development are performed to fire the dry film only on the inner layer pattern. Next, unnecessary portions of the dry film other than the electrically conductive pattern are removed to complete the electrically conductive pattern forming resist. Next, portions of the copper foil other than the electrically conductive pattern are removed by etching. Next, the remaining portion of the etching resist is removed to form an electrically conductive pattern. Next, after the electrically conductive pattern is formed, a solder resist is formed to form a protective layer in order to prevent the solder from adhering to unnecessary portions in the insulation between the electrically conductive patterns and the soldering step. Finally, a surface treatment such as, for example, solder plating, electroless gold plating, or water-soluble flux treatment is performed on the exposed portion of the electrically conductive pattern for the purpose of improving solderability and preventing corrosion of the copper foil portion. As described above, the assembly of the conductor portions 140B, which is an example of the double-sided substrate, is manufactured.

The conductor portion 140D, which is an example of a multilayer substrate, is manufactured as follows. First, the inner layer substrate and the outer layer substrate in which the copper foil is provided on the surface of the insulating base material are cut to predetermined dimensions. Next, dry films (etching resist) are laminated on both main surfaces of the cut material. Next, exposure and development are performed to fire the dry film only on the inner layer pattern. Then, unnecessary portions other than the electrically conductive pattern are removed to complete the electrically conductive pattern forming resist. Next, the copper foil on the portions other than the electrically conductive pattern are removed by etching. Next, the remaining portion of the etching resist is removed to form an electrically conductive pattern. Next, the inner layer substrate on which the electrically conductive pattern has been formed and the outer layer substrate are bonded by pressing using, for example, a prepreg (insulating base material) to manufacture a multilayer substrate. Next, hole forming processing for forming a through hole, a via hole, etc., is performed at a predetermined position of the manufactured multilayer substrate.

Next, in order to electrically connect the copper foil surfaces provided on both main surfaces of the multilayer substrate, interlayer connection conductors (through holes) are formed by through-hole plating. Next, dry films (etching resist) are laminated on both main surfaces of the multilayer substrate. Next, exposure and development are performed to fire the dry film only on the outer layer pattern. Then, unnecessary portions other than the electrically conductive pattern are removed to complete the electrically conductive pattern forming resist. Next, portions of the copper foil other than the electrically conductive pattern are removed by etching. Next, the remaining portion of the etching resist is removed to form an electrically conductive pattern. Next, after the electrically conductive pattern is formed, a solder resist is formed to form a protective layer in order to prevent the solder from adhering to unnecessary portions in the insulation between the electrically conductive patterns and the soldering step. Finally, a surface treatment such as, for example, solder plating, electroless gold plating, or water-soluble flux treatment is performed on the exposed portion of the electrically conductive pattern for the purpose of improving solderability and preventing corrosion of the copper foil portion. As described above, the assembly of the conductor portions 140D, which is an example of the multilayer substrate, is manufactured.

### (c) Method of Manufacturing Composite Electronic Component

Next, the assembly of the conductor portions 140 manufactured by the above-described method is cut and separated, and the multilayer ceramic capacitor 10 manufactured by the above-described method is mounted. The same applies to the conductor portions 140A to 140D.

More specifically, a cutting support tape is attached to the assembly of the conductor portions 140. Next, the assembly of the conductor portions 140 is cut into pieces of a predetermined size. Next, the cut and separated conductor portions 140 are transferred to the heat-resistant plate. At the time of transfer, for example, a heat-resistant tape, an adhesive, or the like may be provided on the heat-resistant plate. Subsequently, the electrically conductive adhesive 70 is printed on the conductor portions 140 which are transferred and cut and separated, and the multilayer ceramic capacitor 10 is mounted by a mounter.

Next, soldering is performed in a reflow furnace. Finally, the cut and separated conductor portions 140 are removed from the heat-resistant plate, and the flux is washed.

As described above, the composite electronic component 1A shown in FIG. 1 is manufactured.

### C. Third Example Embodiment

In a composite electronic component 1B according to a third example embodiment of the present invention, the conductor portion 140 defining and functioning as an interposer substrate in the composite electronic component 1A according to the second example embodiment is also configured as a conductor portion 140E described below.

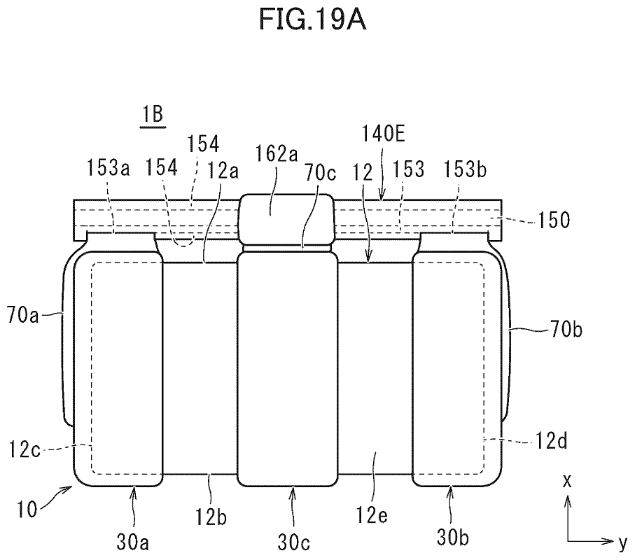

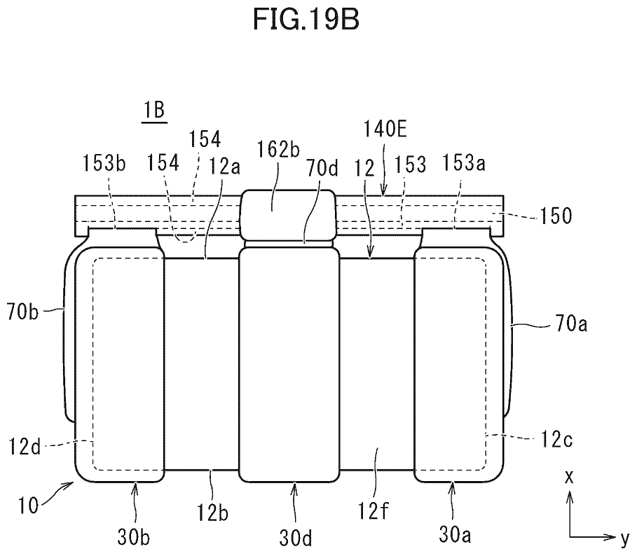

FIG. 18 is an external perspective view showing a composite electronic component according to a third example embodiment of the present invention. FIG. 19A is a front view of a composite electronic component according to a third example embodiment of the present invention, and FIG. 19B is a rear view of the composite electronic component according to the third example embodiment of the present invention.

The conductor portion 140E included in the composite electronic component 1B according to the third example embodiment further includes a first lateral electrode 162a and a second lateral electrode 162b with respect to the conductor portion 140. The conductor portion 140E includes a first lateral electrode 162a connected to the third external electrode 30c by the third electrically conductive adhesive 70c, and a second lateral electrode 162b connected to the fourth external electrode 30d by the fourth electrically conductive adhesive 70d. The exposed electrode portions 153a and 153b are insulated from the first lateral electrode 162a. The exposed electrode portions 153a and 153b are insulated from the second lateral electrode 162b.

According to the composite electronic component 1B of the third example embodiment shown in FIG. 18, the same or substantially the same advantageous effects as those of the composite electronic component 1A of FIG. 12 are achieved, and the following advantageous effects are also achieved. That is, heat generated in the conductor portion 140E is easily dissipated to the outside by the first lateral electrode 162a and the second lateral electrode 162b. Further, since the first lateral electrode 162a and the third external electrode 30c are connected to each other and the second lateral electrode 162b and the fourth external electrode 30d are connected to each other, heat can be more easily dissipated.

### D. Fourth Example Embodiment

In a composite electronic component 1C according to a fourth example embodiment of the present invention, the conductor portion 40 defining and functioning as a chip-type coil component in the composite electronic component 1 according to the first example embodiment is configured as, for example, an interposer substrate as the conductor portion 140A.

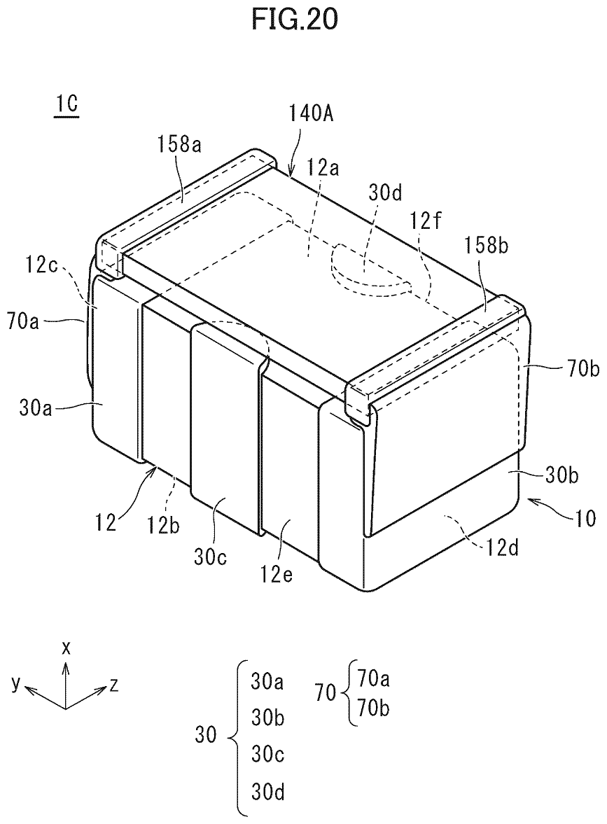

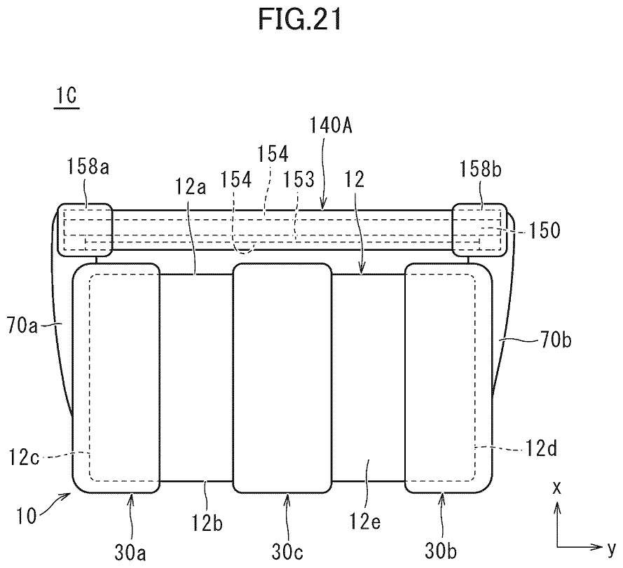

FIG. 20 is an external perspective view showing a composite electronic component according to a fourth example embodiment of the present invention. FIG. 21 is a front view of the composite electronic component according to the fourth example embodiment of the present invention.

The conductor portion 140A included in the composite electronic component 1C according to the fourth example embodiment has the following advantageous features. That is, the dimension of the conductor portion 140A in the first direction y is larger than the dimension (L dimension) of the multilayer ceramic capacitor 10 in the first direction y.

According to the composite electronic component 1C of the fourth example embodiment shown in FIG. 20, the same or substantially the same advantageous effects as those of the composite electronic component 1A of FIG. 12 are achieved, and the following advantageous effects are also achieved. That is, in a case in which the dimension of the conductor portion 140A in the first direction y is set to be larger than the dimension of the multilayer ceramic capacitor 10 in the first direction y and the dimension of the multilayer ceramic capacitor 10 in the second direction z, it becomes easy for the electrically conductive adhesive 70 to sufficiently flow around the multilayer ceramic capacitor 10.

### E. Modification of Multilayer Ceramic Capacitor According to the Present Example Embodiment

Hereinafter, modifications (first modification and second modification) of the multilayer ceramic capacitor in the composite electronic component according to the present example embodiment will be described. In addition, in each of these modifications, components corresponding to those of the above-described example embodiment are denoted by the same reference numerals, and a detailed description thereof is omitted.

### (a) First Modification

The multilayer ceramic capacitor 10A according to a first modification of the present example embodiment is different from the multilayer ceramic capacitor 10 according to the first example embodiment only in the structure of the first multilayer body 12A of the multilayer ceramic capacitor 10A. Therefore, the same or corresponding components as those of the multilayer ceramic capacitor 10 are denoted by the same reference numerals, and a description thereof is omitted.

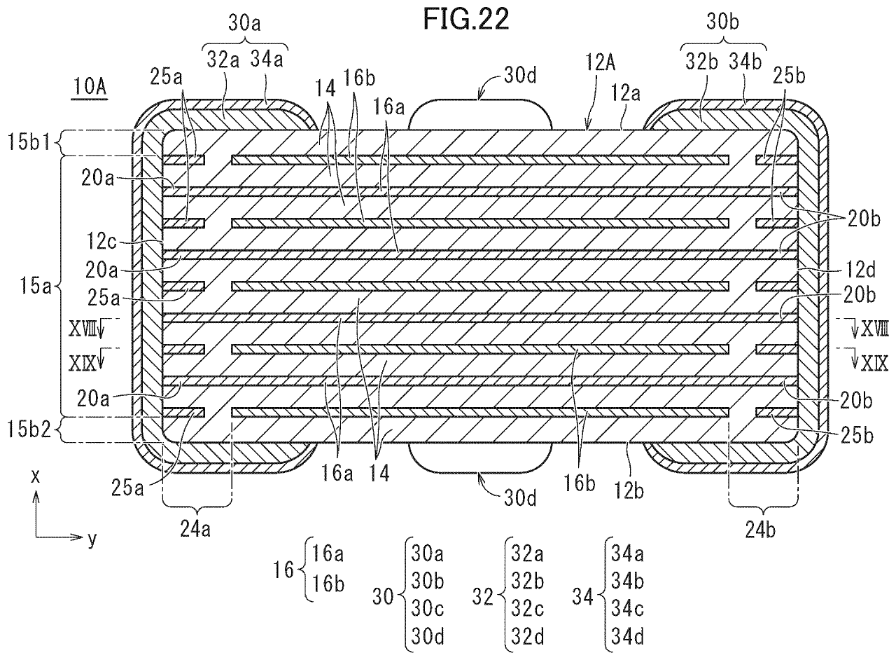

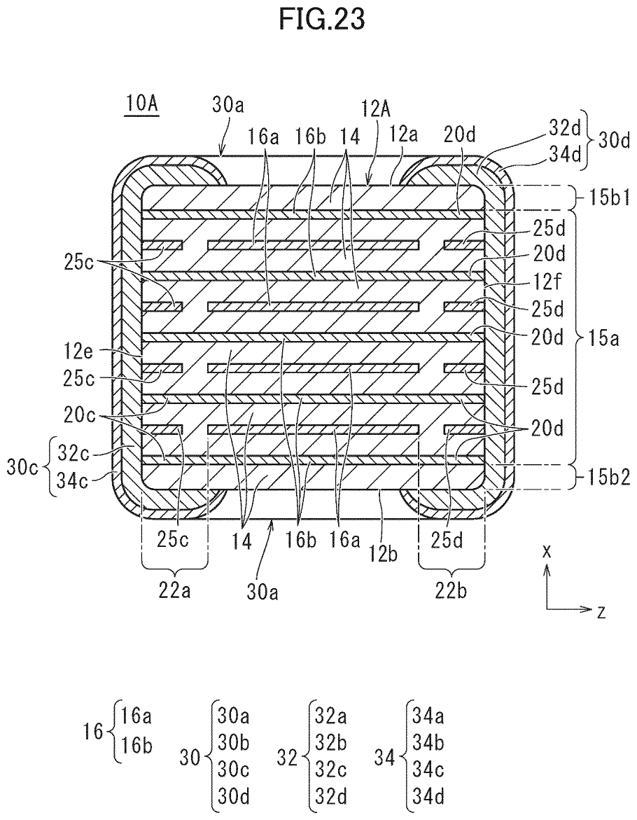

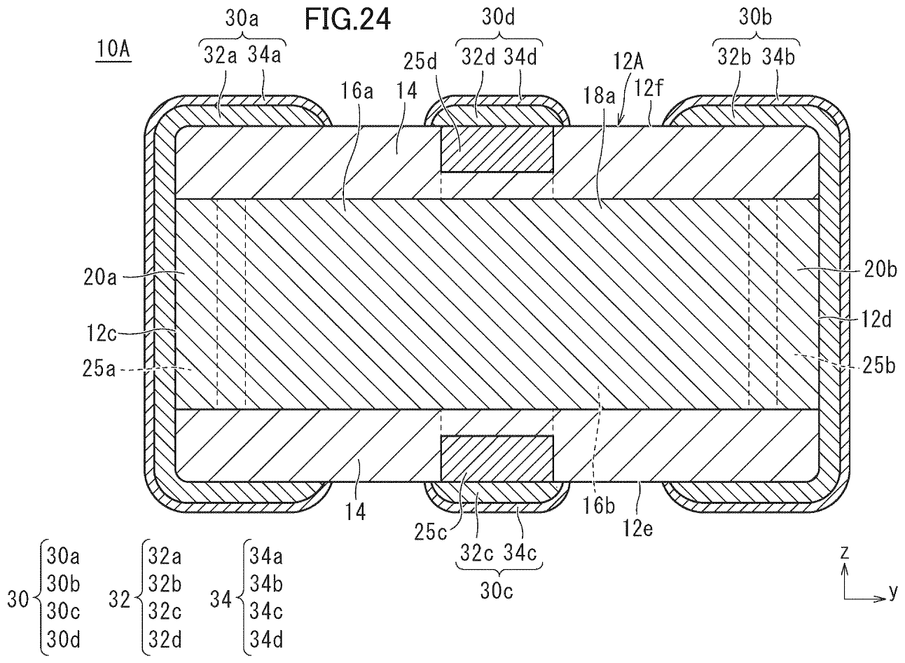

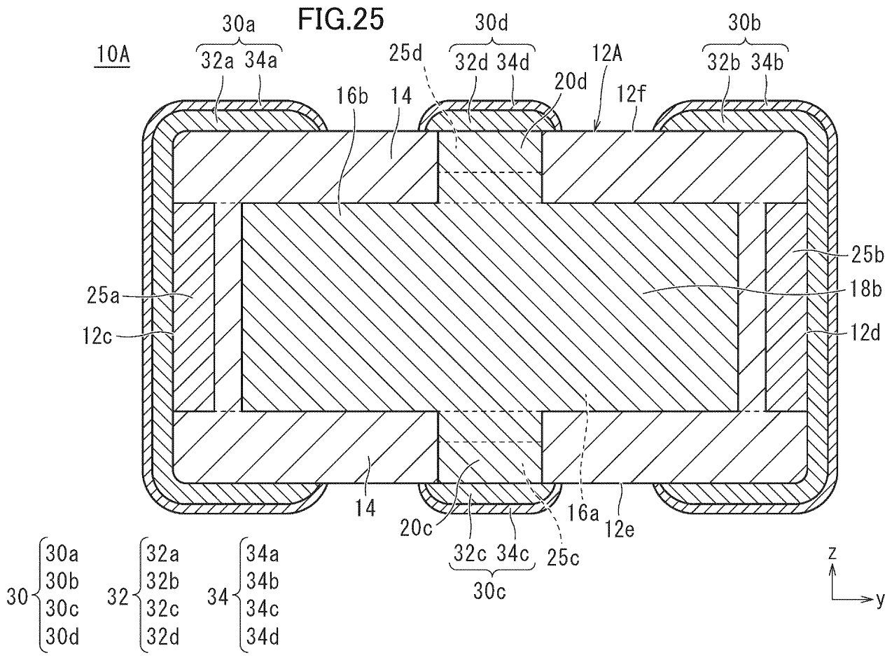

FIG. 22 is a cross-sectional view showing a first modification of the multilayer ceramic capacitor according to the present example embodiment. FIG. 23 is a cross-sectional view showing the first modification of the multilayer ceramic capacitor according to the present example embodiment. FIG. 24 is a cross-sectional view showing a dielectric layer with a first internal electrode layer in the first modification of the multilayer ceramic capacitor according to the present example embodiment. FIG. 25 is a cross-sectional view showing a dielectric layer with a second internal electrode layer in the first modification of the multilayer ceramic capacitor according to the present example embodiment.

The multilayer ceramic capacitor 10A includes a first multilayer body 12A and an external electrode 30.

The first multilayer body 12A includes a plurality of laminated dielectric layers 14. Further, the first multilayer body 12A includes a first surface 12a and a second surface 12b opposed to each other in the lamination direction x, a third surface 12c and a fourth surface 12d opposed to each other in the first direction y orthogonal or substantially orthogonal to the lamination direction x, and a fifth surface 12e and a sixth surface 12f opposed to each other in the second direction z orthogonal or substantially orthogonal to the lamination direction x and the first direction y.

In the end portion (L gap) 24a of the first multilayer body 12A, first dummy electrodes 25a are exposed at the third surface 12c. In the end portion (L gap) 24b of the first multilayer body 12A, second dummy electrodes 25b are exposed at the fourth surface 12d.

Each of the first dummy electrodes 25a and each of the second dummy electrodes 25b are preferably provided on the same or substantially the same plane as corresponding ones of the second internal electrode layers 16b, and have the same or substantially the same thickness as the second internal electrode layers 16b.

In a case in which the coverages of the first dummy electrodes 25a and the second dummy electrodes 25b are reduced, the electric current path can be shortened.

The first dummy electrodes 25a and the second dummy electrodes 25b may also be provided in the first outer layer portion 15b1 and the second outer layer portion 15b2. In this case, it is preferable that the end portions (L gaps) 24a and 24b of the first multilayer body 12A are provided on a portion corresponding to a position where the end portions (L gaps) 24a and 24b are moved in parallel or substantially in parallel in the lamination direction x. With this configuration, in a case in which the plated layer 34 is provided without providing the base electrode layer 32, the plated layer 34 is easily provided.

Further, in a case in which the first dummy electrodes 25a and the second dummy electrodes 25b are provided on the same or substantially the same plane as the second internal electrode layers 16b, the first dummy electrodes 25a and the second dummy electrodes 25b can be provided on the same or substantially the same plane as the second internal electrode layers 16b by printing the first dummy electrodes 25a and the second dummy electrodes 25b together with the second internal electrode layers 16b when the second internal electrode layers 16b are printed.

In addition, in the side portion (W gap) 22a of the first multilayer body 12A, the third dummy electrode 25c may be exposed at the fifth surface 12e, and in the side portion (W gap) 22b of the first multilayer body 12A, the fourth dummy electrode 25d may be exposed at the sixth surface 12f.

Each of the third dummy electrodes 25c and each of the fourth dummy electrodes 25d are preferably provided on the same or substantially the same plane as corresponding ones of the first internal electrode layers 16a, and have the same or substantially the same thickness as the first internal electrode layers 16a.

In a case in which the coverages of the third dummy electrodes 25c and the fourth dummy electrodes 25d are reduced, the electric current path can be shortened.

The third dummy electrodes 25c and the fourth dummy electrodes 25d may also be provided in the first outer layer portion 15b1 and the second outer layer portion 15b2. In this case, it is preferable that the side portions (W gaps) 22a and 22b of the first multilayer body 12A are provided on a portion corresponding to a position where the side portions (W gaps) 22a and 22b are moved in parallel in the lamination direction x. With this configuration, in a case in which the plated layer 34 is provided without providing the base electrode layer 32, the plated layer 34 is easily provided.

Further, in a case in which the third dummy electrode 25c and the fourth dummy electrode 25d are provided on the same or substantially the same plane as the first internal electrode layers 16a, the third dummy electrode 25c and the fourth dummy electrode 25d can be provided on the same or substantially the same plane as the first internal electrode layer 16a by printing the third dummy electrode 25c and the fourth dummy electrode 25d together with the second internal electrode layer 16b when the first internal electrode layer 16a is printed.

In the multilayer ceramic capacitor 10A shown in FIGS. 22 to 25, since the first dummy electrode 25a and the second dummy electrode 25b are provided in the side portions (W gaps) 22a and 22b of the first multilayer body 12A, and the third dummy electrode 25c and the fourth dummy electrode 25d are provided in the end portions (L gaps) 24a and 24b of the first multilayer body 12A, it is possible to prevent distortion during pressing.

### (b) Second Modification

The multilayer ceramic capacitor 10B according to a second modification of the present example embodiment is different from the multilayer ceramic capacitor 10 according to the first example embodiment only in the structure of the first multilayer body 12B of the multilayer ceramic capacitor 10B. Therefore, the same or corresponding components as those of the multilayer ceramic capacitor 10 are denoted by the same reference numerals, and a description thereof is omitted.

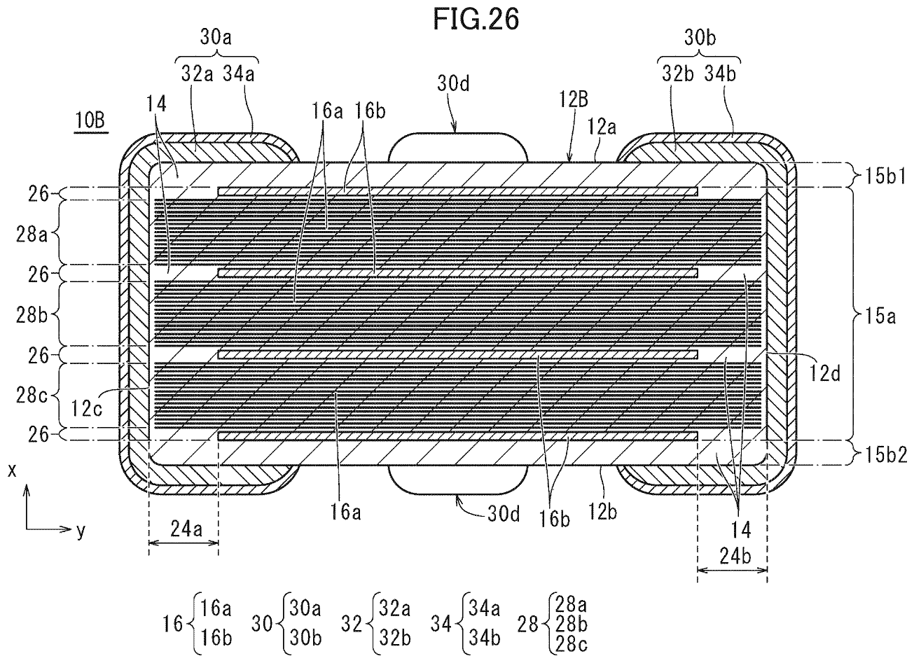

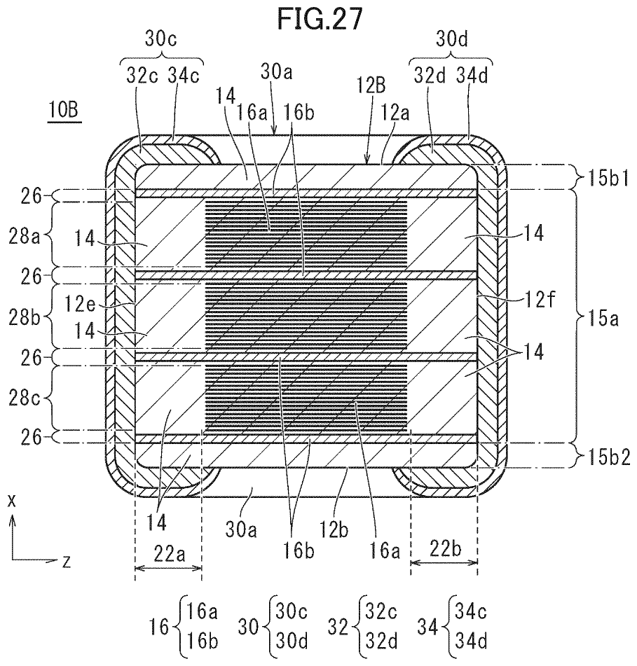

FIG. 26 is a cross-sectional view showing the second modification of the multilayer ceramic capacitor according to the present example embodiment. FIG. 27 is a cross-sectional view showing the second modification of the multilayer ceramic capacitor according to the present example embodiment.

The first multilayer body 12B includes a plurality of laminated dielectric layers 14. Further, the first multilayer body 12B includes a first surface 12a and a second surface 12b opposed to each other in the lamination direction x, a third surface 12c and a fourth surface 12d opposed to each other in the first direction y orthogonal or substantially orthogonal to the lamination direction x, and a fifth surface 12e and a sixth surface 12f opposed to each other in the second direction z orthogonal or substantially orthogonal to the lamination direction x and the first direction y.

The first multilayer body 12B includes an inner layer portion 15a, and a first outer layer portion 15b1 and a second outer layer portion 15b2 that sandwich the inner layer portion 15a in the lamination direction x.

The dielectric layer 14 of the inner layer portion 15a may be sandwiched between the first internal electrode layers 16a and the first internal electrode layers 16a. In this case, the first internal electrode layers 16a and the first internal electrode layers 16a are continuously provided with the dielectric layer 14 of the inner layer portion 15a interposed therebetween.

In addition, the dielectric layer 14 of the inner layer portion 15a may be sandwiched between the second internal electrode layer 16b and the second internal electrode layer 16b. In this case, the second internal electrode layer 16b and the second internal electrode layer 16b are continuously provided with the dielectric layer 14 of the inner layer portion 15a interposed therebetween. The dielectric layer 14 of the inner layer portion 15a is made of, for example, dielectric ceramic particles including a perovskite compound including Ba and Ti as a main component and having a perovskite structure. In addition, for example, at least one of Si, Mg, Ba, and Mn may be added as an additive to these main components. The additive is present between the ceramic particles.

The inner layer portion 15a of the first multilayer body 12B includes a capacitance generating portion 26 in which the first internal electrode layers 16a and the second internal electrode layers 16b are opposed to each other with the dielectric layer 14 interposed therebetween to generate a capacitance, and internal electrode laminated portions 28 which are regions in each of which two or more first internal electrode layers 16a are continuously laminated. In the multilayer ceramic capacitor 10B, the capacitor characteristics are developed by the capacitance generating portion 26.

Further, the internal electrode laminated portions 28 are divided into a plurality of internal electrode laminated portions 28 by the second internal electrode layers 16b. Accordingly, since the assemblies of the first internal electrode layers 16a are separated, the heat dissipation effect is improved, and it is possible to achieve the advantageous effect of reducing or preventing a temperature rise.

As shown in FIGS. 26 and 27, in the multilayer ceramic capacitor 10B, the internal electrode laminated portions 28 are divided by two second internal electrode layers 16b. Specifically, the internal electrode laminated portions 28 are divided into a first internal electrode laminated portion a second internal electrode laminated portion 28b, and a third internal electrode laminated portion 28c.

The second internal electrode layer 16b provided so as to divide the internal electrode laminated portions 28, which are regions in each of which two or more first internal electrode layers 16a are continuously laminated, may be provided singularly. As a result, it is possible to laminate more first internal electrode layers 16a, and it is possible to achieve an advantageous effect of reducing DC resistance.

In addition, the second internal electrode layer 16b provided so as to divide the internal electrode laminated portions 28, which are regions in each of which two or more first internal electrode layers 16a are continuously laminated, may be provided as two or more layers that are continuously laminated. Accordingly, even when the number of the second internal electrode layers 16b is reduced, the connectivity between the second internal electrode layer 16b and the external electrode 30 can be made more sufficient.

The second internal electrode layers 16b may be provided in the internal electrode laminated portion 28, which is a region in which two or more first internal electrode layers 16a located adjacent to the first surface 12a of the first multilayer body 12B are continuously laminated, that is, between the first internal electrode laminated portion 28a and the first surface 12a, and may be provided in the internal electrode laminated portion 28, which is a region in which two or more first internal electrode layers 16a located adjacent to the second surface 12b of the first multilayer body 12B are continuously laminated, that is, between the third internal electrode laminated portion 28c and the second surface 12b. With such a configuration, since the capacitance generating portions 26 can be provided also in the vicinity of the first outer layer portion 15b1 and the second outer layer portion 15b2, a portion of the capacitance can be acquired, the electric current path to the mounting substrate can be shortened, and thus, it is possible to achieve the advantageous effect of low ESL.

The second internal electrode layers 16b may not be provided in the internal electrode laminated portion 28, which is a region in which two or more first internal electrode layers 16a located adjacent to the first surface 12a of the first multilayer body 12B are continuously laminated, that is, between the first internal electrode laminated portion 28a and the first surface 12a, and may not be provided in the internal electrode laminated portion 28, which is a region in which two or more first internal electrode layers 16a located adjacent to the second surface 12b of the first multilayer body 12B are continuously laminated, that is, between the third internal electrode laminated portion 28c and the second surface 12b. With such a configuration, the distance from the surface of the first multilayer body 12B to the capacitance generating portion 26 where the capacitance is generated is increased, and even if a crack is generated from the surface of the first multilayer body 12B due to an external load, it is possible to achieve an advantageous effect in which insulation resistance degradation is less likely to occur.

The thickness of each of the dielectric layers 14 adjacent to the second internal electrode layer 16b is preferably larger than the thickness of each of the dielectric layers 14 sandwiched between the first internal electrode layers 16a. With such a configuration, it is possible to laminate more first internal electrode layers 16a, and it is possible to further increase the advantageous effect of reducing DC resistance.

Further, the thickness of the second internal electrode layer 16b is preferably larger than the thickness of the first internal electrode layer 16a. With such a configurations, even if the capacitance is further reduced, the connectivity between the third extension electrode portion 20c of the second internal electrode layer 16b and the third external electrode 30c provided on the fifth surface 12e can be ensured, and the connectivity between the fourth extension electrode portion 20d of the second internal electrode layer 16b and the fourth external electrode 30d provided on the sixth surface 12f can be ensured.

### F. Examples

Next, in order to confirm the advantageous effects of the composite electronic components according to example embodiments of the present invention described above, composite electronic components, which are samples in each of which the thickness of the ridge portion was varied, were produced as samples for experiments according to the above-described production method, and the temperature rise in each of the composite electronic components due to the difference in the thickness of the ridge portion was evaluated.

### (1) Specifications of Multilayer Ceramic Capacitors Manufactured as Samples of the Examples

Multilayer ceramic capacitors included in the multilayer ceramic electronic components of Sample Nos. 1 to 11 were manufactured by using the manufacturing method according to the above-described example embodiments.
dimensions (design value) of the multilayer ceramic capacitors: L×W×T=about 1.6 mm×about 0.8 mm×about 0.8 mm, ceramic material: BaTiO₃, material of internal electrode layers: Ni, number of first internal electrode layers: 16 sheets, number of second internal electrode layers: 16 sheets, base electrode layer of external electrodes: electrically conductive metal (Cu) and glass component, and two-layer formation of Ni plated layer and Sn plated layer (Ni plated layer thickness: about 3 μm, Sn plated layer thickness: about 5 μm)

### (2) Specifications of Conductor Portion Used as Samples of the Examples

In the Examples, the conductor portion 140 of the above-described example embodiments was used.

$$dimensions ( design value ) of conductor portion : L \times W \times T = about 1.7 mm \times about 0.9 mm \times about 0.4 mm$$

As shown in Table 1, in each of Samples Nos. 1 to 11, samples were prepared in which the thickness ty of the ridge portion was varied.

### (3) Method of Measuring Temperature Rise Value

A temperature at which the composite electronic component itself, which is a sample of each sample number, generates heat at the time of DC current conduction was measured, and a temperature AT obtained by subtracting room temperature from the measured temperature was defined as a temperature rise value. Specifically, a thermocouple was placed on the surface of the composite electronic component as a sample, and the temperature rise value was measured.

ΔT≥about 40° C. was evaluated as “x” (cross symbol indicating poor). About 30° C.≤ΔT<about 40° C. was evaluated as “A” (triangle symbol indicating fair). About 20° C.≤ΔT<about 30° C. was evaluated as “o” (circle symbol indicating good). ΔT<about 20 was evaluated as “O” (bullseye symbol indicating very good). As a method of measuring the temperature of the composite electronic component, a thermocamera may be used to measure the heat generation temperature. The reason why the temperature rise value increases when the DC current flows is that the DC resistance value of the multilayer ceramic capacitor increases. When the temperature rise value of the composite electronic component becomes large, the high-temperature load reliability is lowered. Therefore, in the Examples, the advantageous effects of example embodiments of the present invention were confirmed by experiments on the temperature rise of each of the composite electronic components as samples.

### (4) Results

Table 1 shows the evaluation results of the temperature rise relative to the change in the thickness of the ridge portions in the composite electronic components of the samples of Sample Nos. 1 to 11.

TABLE 1

| Sample | Thickness of ridge | Evaluation result according |
|---|---|---|
| No. | portion (μm) | to temperature rise value |
| 1 | 5 | X |
| 2 | 7 | Δ |
| 3 | 12 | ◯ |
| 4 | 28 | ◯ |
| 5 | 33 | ◯ |
| 6 | 49 | ◯ |
| 7 | 62 | ⊚ |
| 8 | 72 | ⊚ |
| 9 | 85 | ⊚ |
| 10 | 91 | ⊚ |
| 11 | 103 | ⊚ |

According to Table 1, focusing on the result of the bonding test, “x” (cross symbol) was determined when the thickness of the ridge portion was about 5 μm as shown in Sample No. 1, and “A” (triangle symbol) was determined when the thickness of the ridge portion was about 7 μm as shown in Sample No. 2. Further, as shown in Samples Nos. 3 to 6, results were obtained as “o” (circle symbol) when the thickness of the ridge portion was 12 μm or more and about 49 μm or less, and as shown in Samples Nos. 7 to 11, results were obtained as “O” (bullseye symbol) when the thickness of the ridge portion was about 62 μm or more and about 103 μm or less. As a result, it was confirmed that the temperature rise of the composite electronic component was reduced or prevented by increasing the thickness of the ridge portion.

From the above results, in example embodiments of the present invention, since the electrically conductive adhesive extends from the first region to the second region in the first external electrode, by setting the thickness of at least one ridge portion of the multilayer ceramic capacitor within a predetermined range, the volume of the metal component in the ridge portion can be increased. Therefore, it is suggested that, as the thickness of the ridge portion of the multilayer ceramic capacitor is increased, the temperature rise of the composite electronic component can be reduced or prevented, and as a result, the increase in the electrical resistance of the composite electronic component is reduced or prevented.

As described above, example embodiments of the present invention are disclosed in the above description, but the present invention is not limited thereto.

In other words, various changes can be made to the above-described example embodiments in terms of the mechanism, shape, material, quantity, position, arrangement, or the like without departing from the technical concept and scope of the present invention, and these changes are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A composite electronic component comprising:
a multilayer ceramic capacitor; and
a conductor portion; wherein
the multilayer ceramic capacitor includes:
a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction;
a first external electrode on the first surface and the third surface;
a second external electrode on the first surface and the fourth surface;
a third external electrode on the fifth surface and the first surface; and
a fourth external electrode on the sixth surface and the first surface;
the conductor portion is electrically connected to the first external electrode and the second external electrode;
the first external electrode includes a first region on a surface adjacent to the first surface and a second region on a surface adjacent to the third surface;
the conductor portion includes:
a first electrode connected to the first external electrode by a first electrically conductive adhesive; and
a second electrode connected to the second external electrode by a second electrically conductive adhesive;
when a DC resistance of the multilayer ceramic capacitor is defined as Rdc1 and a DC resistance of the conductor portion is defined as Rdc2, Rdc2≤Rdc1 is satisfied; and
the first electrically conductive adhesive extends from the first region to the second region of the first external electrode.

2. The composite electronic component according to claim 1, wherein
the second external electrode includes a third region on a surface adjacent to the first surface and a fourth region on a surface adjacent to the fourth surface; and
the second electrically conductive adhesive extends from the third region to the fourth region of the second external electrode.

3. The composite electronic component according to claim 1, wherein, in a cross section parallel or substantially parallel to the fifth surface or the sixth surface of the multilayer body and cut at a length of about one half of a dimension of the multilayer body in the second direction, a total thickness of a thickness of the first external electrode and a thickness of the first electrically conductive adhesive along an extension line of the first surface in the cross section is about 7 μm or more.

4. The composite electronic component according to claim 2, wherein, in a cross section parallel or substantially parallel to the fifth surface or the sixth surface of the multilayer body and cut at a length of about one half of a dimension of the multilayer body in the second direction, a total thickness of a thickness of the second external electrode and a thickness of the second electrically conductive adhesive along an extension line of the first surface in the cross section is about 7 μm or more.

5. The composite electronic component according to claim 1, wherein, in a cross section parallel or substantially parallel to the fifth surface or the sixth surface of the multilayer body and cut at a length of one half of a dimension of the multilayer body in the second direction, a total thickness of a thickness of the first external electrode and a thickness of the first electrically conductive adhesive along an extension line of the first surface in the cross section is about 12 μm or more.

6. The composite electronic component according to claim 2, wherein, in a cross section parallel or substantially parallel to the fifth surface or the sixth surface of the multilayer body and cut at a length of about one half of a dimension of the multilayer body in the second direction, a total thickness of a thickness of the second external electrode and a thickness of the second electrically conductive adhesive along an extension line of the first surface in the cross section is about 12 μm or more.

7. The composite electronic component according to claim 1, wherein, in a cross section parallel or substantially parallel to the fifth surface or the sixth surface of the multilayer body and cut at a length of about one half of a dimension of the multilayer body in the second direction, a total thickness of a thickness of the first external electrode and a thickness of the first electrically conductive adhesive along an extension line of the first surface in the cross section is about 62 μm or more.

8. The composite electronic component according to claim 2, wherein, in a cross section parallel or substantially parallel to the fifth surface or the sixth surface of the multilayer body and cut at a length of one half of a dimension of the multilayer body in the second direction, a total thickness of a thickness of the second external electrode and a thickness of the second electrically conductive adhesive along an extension line of the first surface in the cross section is about 62 μm or more.

9. The composite electronic component according to claim 1, wherein the conductor portion is a chip coil component.

10. The composite electronic component according to claim 2, wherein the conductor portion is a chip coil component.

11. The composite electronic component according to claim 1, wherein
an insulating resin is provided between the conductor portion and the multilayer ceramic capacitor; and
the insulating resin covers at least a portion of the multilayer ceramic capacitor.

12. The composite electronic component according to claim 2, wherein
an insulating resin is provided between the conductor portion and the multilayer ceramic capacitor; and
the insulating resin covers at least a portion of the multilayer ceramic capacitor.

13. The composite electronic component according to claim 1, wherein
an insulating resin is provided between the conductor portion and the multilayer ceramic capacitor; and
the insulating resin covers at least a portion of the conductor portion.

14. The composite electronic component according to claim 2, wherein
an insulating resin is provided between the conductor portion and the multilayer ceramic capacitor; and
the insulating resin covers at least a portion of the conductor portion.

15. The composite electronic component according to claim 1, wherein
an insulating resin is provided between the conductor portion and the multilayer ceramic capacitor; and
the insulating resin covers at least a portion of the multilayer ceramic capacitor and at least a portion of the conductor portion.

16. The composite electronic component according to claim 2, wherein
an insulating resin is provided between the conductor portion and the multilayer ceramic capacitor; and
the insulating resin covers at least a portion of the multilayer ceramic capacitor and at least a portion of the conductor portion.

17. The composite electronic component according to claim 1, wherein the multilayer body includes:
a first internal electrode layer connected to the first external electrode and the second external electrode; and
a second internal electrode layer connected to the third external electrode and the fourth external electrode.

18. The composite electronic component according to claim 2, wherein the multilayer body includes:
a first internal electrode layer connected to the first external electrode and the second external electrode; and
a second internal electrode layer connected to the third external electrode and the fourth external electrode.

19. The composite electronic component according to claim 1, wherein the conductor portion includes:
a third electrode connected to the third external electrode by a third electrically conductive adhesive; and
a fourth electrode connected to the fourth external electrode by a fourth electrically conductive adhesive; and
the first electrode is insulated from at least one of the third electrode or the fourth electrode; and
the second electrode is insulated from at least one of the third electrode or the fourth electrode.

20. The composite electronic component according to claim 1, wherein the first electrically conductive adhesive or the second electrically conductive adhesive includes a void therein.
